(19) United States
(12) Patent Application Publication
(10) Pub. No.: US 2026/0360838 A1
(43) Pub. Date: Nov. 12, 2026

(54) BATTERY PACK AND BATTERY RECEPTACLE

(71) Applicant: BRIGGS & STRATTON, LLC, Wauwatosa, WI (US)

(72) Inventors: Ross Eernisse, Wauwatosa, WI (US); James M. Busse, Kenosha, WI (US); John Schneiker, Muskego, WI (US); Matthew Mergener, Wauwatosa, WI (US); Yomi Ladeinde, Milwaukee, WI (US); David Duch, Sussex, WI (US)

(73) Assignee: BRIGGS & STRATTON, LLC, Wauwatosa, WI (US)

(21) Appl. No.: 19/111,886

(22) PCT Filed: Sep. 18, 2023
(86) PCT No.: PCT/US2023/033002

§ 371 Date: Mar. 14, 2025

Related U.S. Application Data
(60) Provisional application No. 63/407,270, filed on Sep. 16, 2022.
(60) Provisional application No. 63/463,699, filed on May 3, 2023.
(60) Provisional application No. 63/467,118, filed on May 17, 2023.

(51) Int. Cl. H01M 10/42; H01M 10/48; H01M 50/213; H01M 50/224; H01M 50/242; H01M 50/262; H01M 50/284; H01M 50/298; H01M 50/503; H01M 50/507; H02J 7/50; H02J 7/82

(52) U.S. Cl. CPC H01M 10/425; H01M 10/482; H01M 10/488; H01M 50/213; H01M 50/224; H01M 50/242; H01M 50/262; H01M 50/284; H01M 50/298; H01M 50/503; H01M 50/507; H01M 2010/4271; H02J 7/50; H02J 7/82

(57) ABSTRACT

A battery pack assembly includes a battery pack and a dock assembly. The battery pack includes a plurality of battery cells, a plurality of collector plates each connected to a subset of the plurality of battery cells, a PCB sense board coupled to the plurality of collector plates through a plurality of wires, an outer housing configured to enclose the plurality of cells, a handle extending from the outer housing, an electrical receptacle located on a side of the outer housing, the electrical receptacle comprising a plurality of ports, and a rail coupled to the outer housing and including a mounting aperture. The dock assembly includes a body and an electrical connector configured to connect to the electrical receptacle. The dock assembly is configured to couple to the outer housing via a fastener extending through the body and into the mounting aperture.

### CROSS-REFERENCE TO RELATED PATENT APPLICATIONS

This application claims the benefit of and priority to U.S. Provisional Patent Application No. 63/467,118, filed May 17, 2023, U.S. Provisional Patent Application No. 63/463,699, filed May 3, 2023, and U.S. Provisional Patent Application No. 63/407,270, filed Sep. 16, 2022, each of which is hereby incorporated by reference herein.

### BACKGROUND

Battery packs may be implemented to provide power to indoor and outdoor power equipment.

### SUMMARY

At least one embodiment relates to a battery pack assembly. The battery pack assembly includes a battery pack and a dock assembly. The battery pack includes a plurality of battery cells, a plurality of collector plates each connected to a subset of the plurality of battery cells, a PCB sense board coupled to the plurality of collector plates through a plurality of wires, an outer housing configured to enclose the plurality of cells, a handle extending from the outer housing, an electrical receptacle located on a side of the outer housing, the electrical receptacle comprising a plurality of ports, and a rail coupled to the outer housing and including a mounting aperture. The dock assembly includes a body and an electrical connector configured to connect to the electrical receptacle. The dock assembly is configured to couple to the outer housing via a fastener extending through the body and into the mounting aperture.

Another embodiment relates to a battery pack assembly. The battery pack assembly includes a battery pack and a dock assembly. The battery pack includes a plurality of battery cells, a plurality of collector plates each connected to a subset of the plurality of battery cells, a PCB sense board coupled to the plurality of collector plates through a plurality of wires, and an outer housing configured to enclose the cell module assembly. The dock assembly includes a body with a punch out that is configured to be removed and form an aperture that extends through the body.

Another embodiment relates to a battery pack. The battery pack includes a cell module assembly having a plurality of battery cells, a plurality of collector plates each connected to a subset of the plurality of battery cells, and a PCB sense board coupled to the plurality of collector plates through a plurality of wires. The battery pack further includes a battery management system coupled to the PCB sense board though an electrical wiring harness, and an outer housing configured to enclose the cell module assembly.

Another embodiment relates to a battery pack assembly. The battery pack assembly includes a battery pack and a dock assembly. The battery pack includes an outer housing, a cell module assembly enclosed within the outer housing and having a plurality of battery cells, and an electrical receptacle arranged within the outer housing and having a plurality of ports. The dock assembly includes an electrical connector having a plurality of pins and a floating carrier, and an ejector pin configured to bias against the outer housing. When the battery pack is installed onto the dock assembly, the floating carrier is configured to allow the plurality of pins to move relative to the plurality of ports to align each of the plurality of pins with a corresponding one of the plurality of ports.

Another embodiment relates to a battery pack assembly. The battery pack assembly includes a battery pack and a dock assembly. The battery pack includes an outer housing having a receptacle opening, a cell module assembly enclosed within the outer housing, and an electrical receptacle arranged within the outer housing and having a plurality of ports. The dock assembly includes a lever, an electrical connector having a plurality of pins and a floating carrier, and an ejector pin configured to bias against the outer housing. The plurality of pins includes a power pin and a communication pin. When the lever is moved to unlock the battery pack from the dock assembly, the ejector pin is configured to move the battery pack to a partially removed position where the power pin remains engaged and the communication pin is disengaged.

Another embodiment relates to a battery pack. The battery pack includes a connector having a plurality of ports. The plurality of ports includes a positive battery port posited on a first side of the connector, a negative battery port positioned on a second side of the connector, an enable port including a high-power enable terminal and a low-power enable terminal, and a CAN port positioned between the enable port and the positive battery port.

Another embodiment relates to a battery pack. The battery pack includes a plurality of battery cells, and a connector having a plurality of ports. The plurality of ports includes a positive battery port, a negative battery port, an enable port including a low-power enable terminal and a high-power enable terminal, a CAN port, and an auxiliary port having an auxiliary power terminal. The battery pack further includes a battery management system in communication with the connector and configured to detect a low-power activation signal at the low-power enable terminal, in response to detecting the low-power activation signal, enable auxiliary power at the auxiliary power terminal, detect a high-power activation signal at the high-power enable terminal, and in response to detecting the low-power activation signal and the high-power activation signal, enable primary power output from the plurality of battery cells at the positive battery port and the negative battery port.

Another embodiment relates to a method of enabling power output in a battery pack. The method includes receiving a first commanded action at an enable port, enabling auxiliary power at an auxiliary port in response to the first commanded action, receiving a second commanded action at the enable port or a CAN port, and in response to receiving the first commanded action and the second commanded action, enabling primary power at a positive battery port and a negative battery port.

Another embodiment relates to a battery pack. The battery pack includes a connector having a positive battery port, a negative battery port, an auxiliary power terminal, a high-power enable terminal configured to receive a high-power enable signal, and a low-power enable terminal configured to receive a low-power enable signal. The battery pack further includes a processing circuit electrically connected to the connector and including a memory and a processor, the memory storing instructions that, when executed by the processor, cause the processing circuit to receive, at the low-power enable terminal, a shutdown request, deactivate the positive battery port and the negative battery port, in response to receiving the shutdown request, and deactivate the auxiliary power terminal a predetermined amount of time after receiving the shutdown request.

Another embodiment relates to a battery pack. The battery pack includes a connector having a positive battery port, a negative battery port, an auxiliary power terminal, a high-power enable terminal configured to receive a high-power enable signal, a low-power enable terminal configured to receive a low-power enable signal, and a CAN port. The battery pack includes a processing circuit electrically connected to the connector and including a memory and a processor, the memory storing instructions that, when executed by the processor, cause the processing circuit to receive, via the CAN port, a shutdown request including a delay instruction, deactivate the positive battery port and the negative battery port in response to receiving the shutdown request, and deactivate the auxiliary power terminal an amount of time indicted in the delay instruction after receiving the shutdown request.

Another embodiment relates to a battery pack. The battery pack includes a connector having a positive battery port, a negative battery port, an auxiliary power terminal, a high-power enable terminal configured to receive a high-power enable signal, a low-power enable terminal configured to receive a low-power enable signal, and an I/O terminal. The battery pack further includes a processing circuit electrically connected to the connector and including a memory and a processor, the memory storing instructions that, when executed by the processor, cause the processing circuit to receive, at the I/O terminal, an inhibit signal, and deactivate the positive battery port and the negative battery port a predetermined amount of time after receiving the inhibit signal.

Another embodiment relates to a battery pack. The battery pack includes a housing, a plurality of battery cells arranged within the housing, a circuit element arranged within the housing, wherein the circuit element includes a heating element and a fuse, and a battery management system arranged within the housing and in communication with the plurality of battery cells and the circuit element. The battery management system is configured to monitor a voltage of the plurality of battery cells, detect an over-voltage charging event when the voltage of the plurality of battery cells is greater than or equal to an over-charge voltage threshold, determine if the voltage of the plurality of battery cells is greater than or equal to the over-charge voltage threshold for a predetermined amount of time, and in response to determining that the voltage of the plurality of battery cells is greater than or equal to the over-charge voltage threshold for the predetermined amount of time, initiating a disconnect process by sending a current signal to the heating element.

Another embodiment relates to a method for initiating a disconnect process in a battery pack. The method includes charging a battery cell within a battery pack, monitoring a voltage of the battery cell during charging, detecting that the voltage is greater than or equal to an over-charge voltage threshold, determining if the voltage remains greater than or equal to the over-charge voltage threshold for a predetermined amount of time, and in response to determining that the voltage remains greater than or equal to the over-charge voltage threshold for the predetermined amount of time, initiating a disconnect process by sending a current signal from a battery management system within the battery pack through a heating element to melt a fuse within the battery pack.

Another embodiment relates to a battery pack. The battery pack includes a housing, a plurality of battery cells arranged within the housing, a circuit element arranged within the housing, wherein the circuit element includes a heating element and a fuse, and a battery management system arranged within the housing and in communication with the plurality of battery cells and the circuit element, The battery management system being configured to monitor a discharge current of the plurality of battery cells, detect a high-current discharge event when the discharge current of the plurality of battery cells is greater than or equal to an upper discharge current threshold, determine if the discharge current of the plurality of battery cells drops to a value that is less than or equal to a lower discharge current threshold, and in response to determining that the discharge current of the plurality of battery cells is less than or equal to the lower discharge current threshold, initiating a disconnect process by sending a current signal to the heating element.

Another embodiment relates to a method for initiating a disconnect process in a battery pack. The method includes discharging a battery cell within a battery pack to power an electrical load, monitoring a discharge current of the battery cell as the battery cell powers the electrical load, detecting that the discharge current is greater than or equal to an upper discharge current threshold, determining if the discharge current of the battery cell drops to a value that is less than or equal to a lower discharge current threshold, and in response to determining that the discharge current of the battery cell is less than or equal to the lower discharge current threshold, initiating a disconnect process by sending a current signal from a battery management system within the battery pack through a heating element to melt a fuse within the battery pack.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, in which:

FIG. 1 is a perspective view of a battery pack according to some embodiments;

FIG. 2 is a rear perspective view of the battery pack of FIG. 1;

FIG. 3 is a front view of the battery pack of FIG. 1;

FIG. 4 is a top view of the battery pack of FIG. 1;

FIG. 5 is a side view of the battery pack of FIG. 1;

FIG. 6 is front perspective view of a cell module assembly housed within the battery pack of FIG. 1;

FIG. 7 is back perspective view of a cell module assembly of FIG. 6;

FIG. 8 is a schematic illustration of a battery management system of the battery pack of FIG. 1 coupled to a user interface;

FIG. 9 is a perspective view of a dock assembly for coupling the battery pack of FIG. 1 to a battery receptacle;

FIG. 10 is a back view of the dock assembly of FIG. 9;

FIG. 11 is a bottom view of the dock assembly of FIG. 9;

FIG. 12 is a front view of the dock assembly of FIG. 9 with a wiring cover hidden;

FIG. 13 is a perspective view of an electrical connector of the dock assembly of FIG. 9;

FIG. 14 is a perspective view of the electrical connector of FIG. 13;

FIG. 15 is a perspective view of a body of the dock assembly of FIG. 9;

FIG. 16 is a cross-sectional view of the electrical connector and the body of the dock assembly of FIG. 9;

FIG. 17 is a cross-sectional view of the dock assembly of FIG. 9;

FIG. 18 is a side view of the dock assembly of FIG. 9 coupled to the battery pack of FIG. 1;

FIG. 19 is a cross-sectional view of the battery pack of FIG. 1 coupled to the dock assembly of FIG. 9;

FIG. 20 is a cross-sectional view of the battery pack of FIG. 1 showing an ejector pin of the dock assembly of FIG. 9;

FIG. 21 is a cross-sectional view of the battery pack of FIG. 1 with an electrical connector of the dock assembly of FIG. 9 in a partially removed position;

FIG. 22 is a perspective view of a fixed electrical connector configured to couple to the battery pack of FIG. 1;

FIG. 23 is a perspective view of the fixed electrical connector of FIG. 22 installed on the battery pack of FIG. 1;

FIG. 24 is a perspective view of the fixed electrical connector of FIG. 22 and a terminal cover installed on the battery pack of FIG. 1;

FIG. 25 is a schematic illustration of the electrical connections between the multiple removable battery packs, a control unit, a charging circuit and a motor according to some embodiments;

FIG. 26 is a bottom plan view of a receptacle or connector of the battery pack of FIG. 1, according to some embodiments;

FIG. 27 is a schematic illustration of the connector of FIG. 26 in communication with a switch/button and a controller/ECU;

FIG. 28 illustrates a method of enabling primary power from the connector of FIG. 26;

FIG. 29 illustrates a method of enabling a controlled shutdown of equipment coupled to the connector of FIG. 26;

FIG. 30 illustrates a method of enabling a controlled shutdown of CAN-enabled equipment coupled to the connector of FIG. 26;

FIG. 31 illustrates a method of enabling a controlled shutdown of equipment coupled to the connector of FIG. 26 in response to an inhibit signal;

FIG. 32 is a schematic illustration of the battery pack of FIG. 1 including a consumable circuit element, according to some embodiments;

FIG. 33 is a schematic illustration of the battery pack of FIG. 1 including a plurality of circuit elements arranged in parallel;

FIG. 34 illustrates a method of initiating a disconnect process in the battery pack of FIG. 32 after detection of an over-voltage charging event;

FIG. 35 illustrates a method of initiating a disconnect process in the battery pack of FIG. 32 after detection of a high-current discharge event;

FIG. 36 is a perspective view of a back portion of an outer housing of the battery pack of FIG. 1 including damping pads;

FIG. 37 is a perspective view of a front portion of an outer housing of the battery pack of FIG. 1 including damping pads;

FIG. 38 is cross-sectional view of the front portion of FIG. 37 with a cell module assembly installed;

FIG. 39 is a cross-section view of the back portion of FIG. 36 with a cell module assembly installed; and

FIG. 40 is a perspective view of the battery pack of FIG. 1 with a user interface arranged away from a housing interface.

It will be recognized that the figures are the schematic representations for purposes of illustration. The figures are provided for the purpose of illustrating one or more implementations with the explicit understanding that the figures will not be used to limit the scope of the meaning of the claims.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring to the figures generally, the battery pack and battery pack assemblies described herein may be used in chore products, including outdoor power equipment, standby generators, portable jobsite equipment, or other appropriate uses. Outdoor power equipment may include lawn mowers, riding tractors, snow throwers, pressure washers, portable generators, tillers, log splitters, zero-turn radius mowers, walk-behind mowers, wide-area walk-behind mowers, riding mowers, standing mowers, industrial vehicles such as forklifts, utility vehicles, etc. Outdoor power equipment may, for example, use an internal combustion engine to drive an implement, such as a rotary blade of a lawn mower, a pump of a pressure washer, an auger of a snow thrower, the alternator of a generator, and/or a drivetrain of the outdoor power equipment. Portable jobsite equipment includes portable light towers, mobile industrial heaters, and portable light stands.

A “chore product” as used herein refers to any type of equipment, machine, or vehicle that may be used to perform a chore (e.g., an outdoor chore, an indoor chore, lawn care, etc.). For example, a chore product may include a motor, a pump, an actuator, a compressor, and/or another device that is electrically powered to operate some function of the chore product to facilitate performing a chore. In some embodiments, a chore is a task performed, either by a user or autonomously, at or near a household, a farm, an agricultural facility, a building, a sidewalk, a park, a parking lot, a forest, a field, and/or a lawn. In some embodiments, a chore product transports an operator and performs a chore. In some embodiments, a chore product autonomously operates to perform a chore without an operator being present on the chore product or physically/manually manipulating the chore product.

### Battery Pack

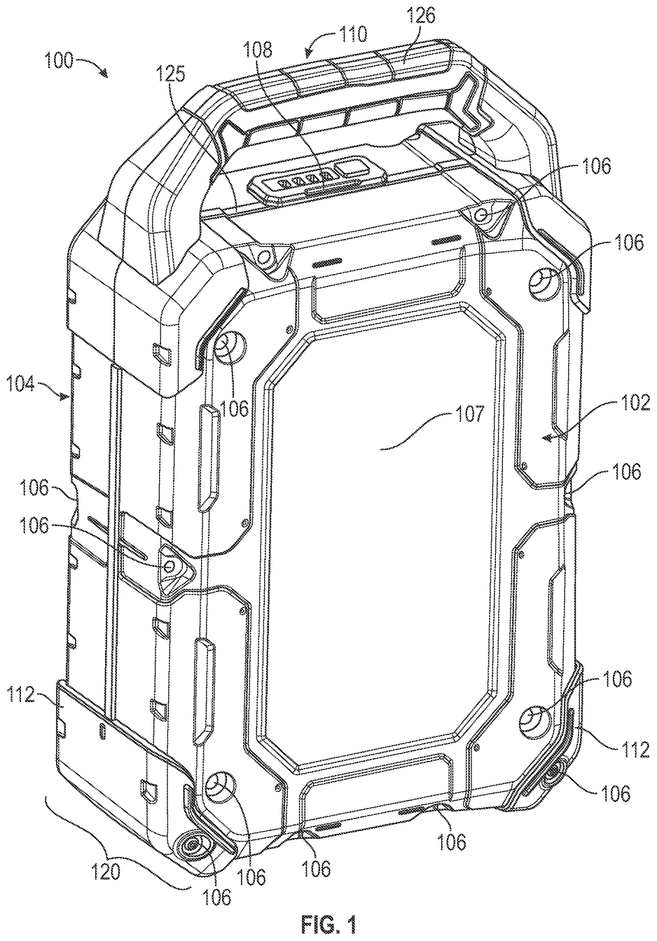

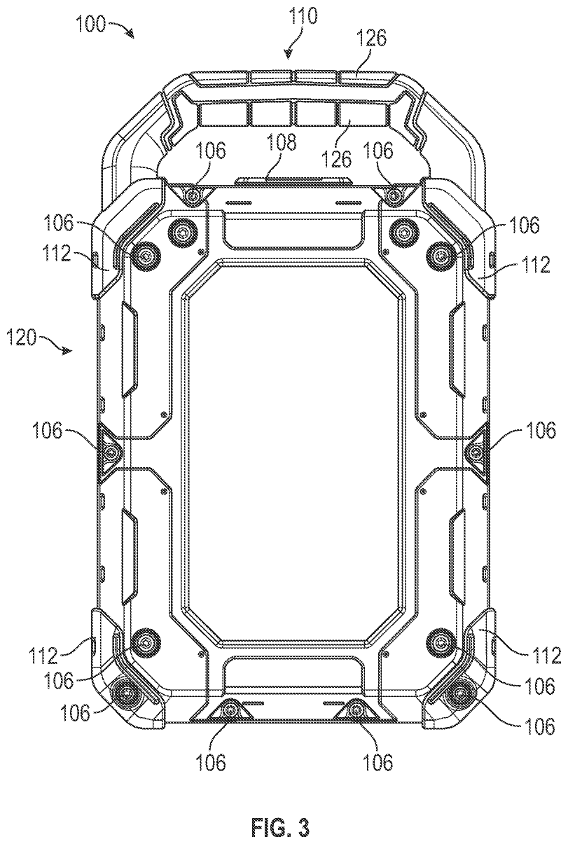

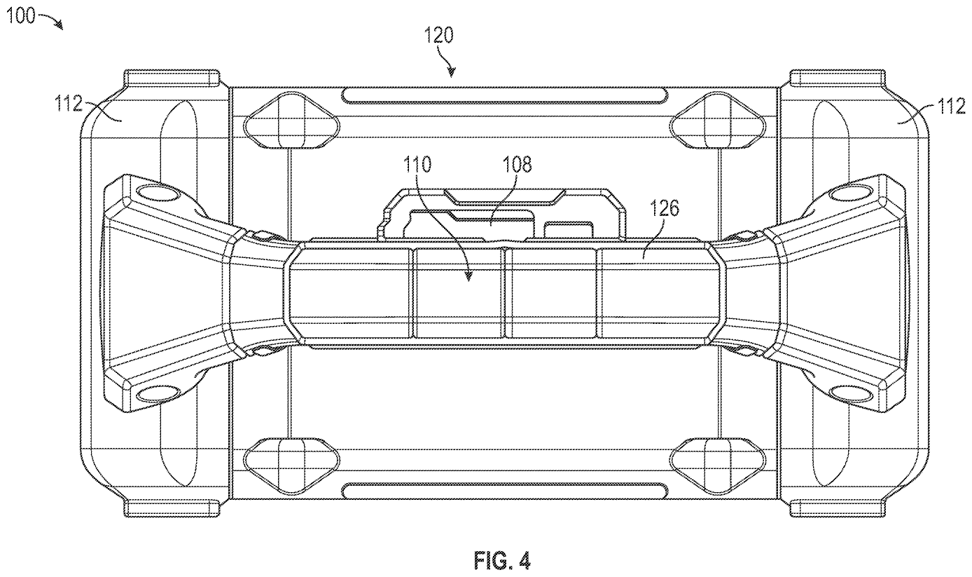

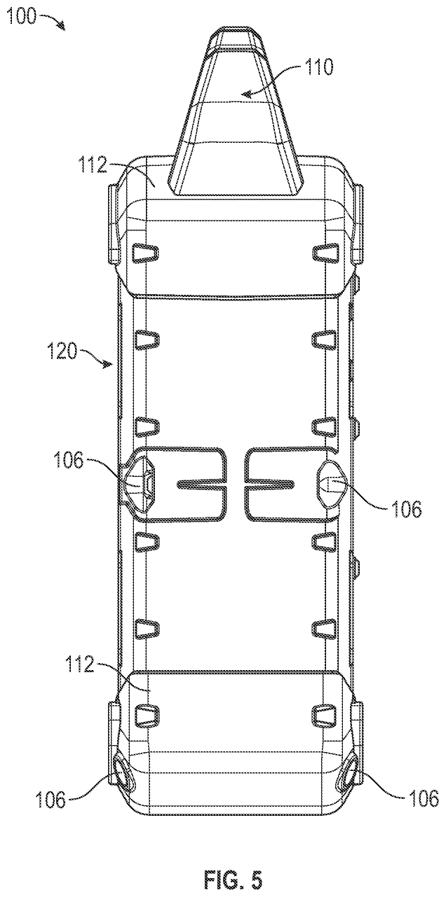

Referring now to FIGS. 1-5, a battery pack 100 is shown, according to an exemplary embodiment. In some embodiments, the battery pack 100 is removable and rechargeable. The battery pack 100 is configured to be inserted (e.g., dropped, lowered, placed) into a receptacle integrated with a piece of power equipment, a chore product, and/or a charging station. In some embodiments, the battery pack 100 is configured to provide electrical power to a chore product or outdoor power equipment.

The battery pack 100 can be installed into a piece of equipment or chore product vertically, horizontally, and/or at any angle. In some embodiments, the battery pack 100 may be a Lithium-ion battery. However, other battery types are contemplated, such as nickel-cadmium (NiCD), lead-acid, nickel-metal hydride (NiMH), lithium polymer, etc. In some embodiments, the battery pack 100 yields a voltage of between approximately 12 and approximately 200 Volts (V) and a capacity between approximately 200 and approximately 1500 Watt-hours (Wh) of energy. In some embodiments, the battery pack 100 may have a peak discharge current of 200 Amperes (A). It is contemplated that battery assemblies of other sizes may also be used. For example, the battery pack 100 may include a capacity that is between about 1000 Wh and about 2000 Wh, or between about 1100 Wh and about 1900 Wh, or between about 1200 Wh and 1800 Wh.

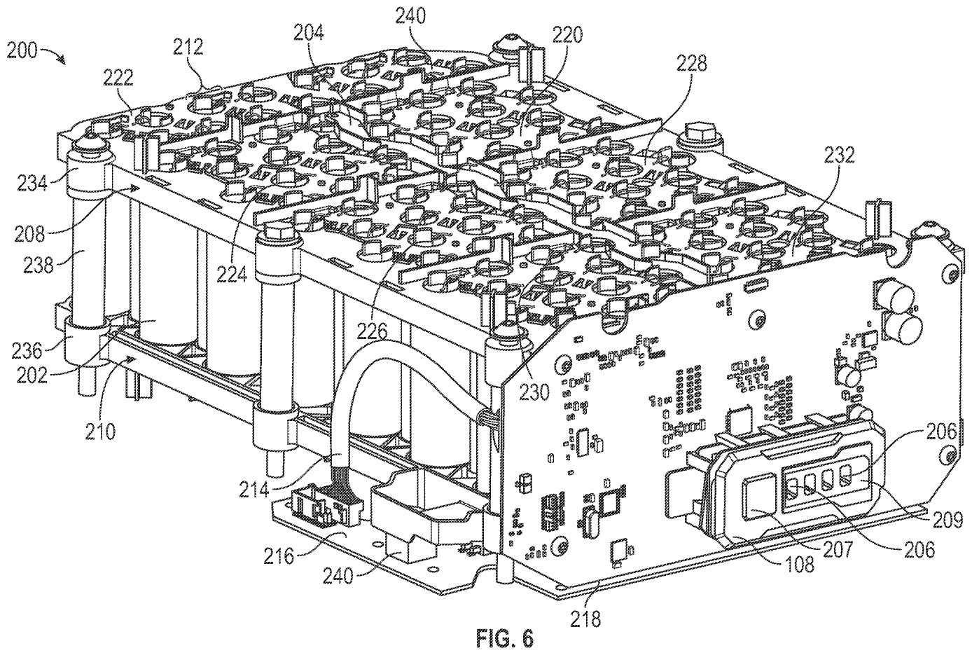

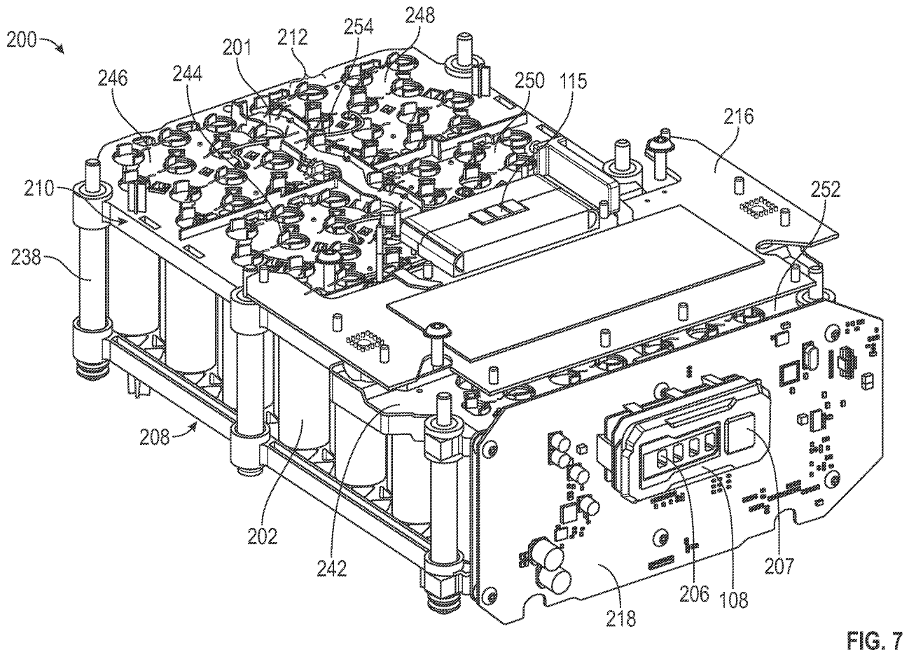

The battery pack 100 includes one or more battery cell module assemblies 200 positioned therein. The one or more cell module assemblies 200 are described in or detail below with respect to FIGS. 6-7 below. The battery pack 100 may also be hot-swappable, meaning that a drained battery pack 100 can be exchanged for a new battery pack 100 without completely powering down connected equipment. As such, downtime between battery pack 100 exchanges is eliminated.

The battery pack 100 can be removed by an operator from a piece of equipment or chore product without the use of tools and recharged using a charging station, as described further herein. In this way, the operator may use a second rechargeable battery having a sufficient charge to power equipment while allowing the first battery to recharge. Due to its uniformity across equipment, the battery pack 100 can also be used as part of a rental system, where rental companies who traditionally rent out pieces of equipment can also rent the battery pack 100 to be used on such equipment. An operator can rent a battery pack 100 to use on various types of equipment the operator may own and/or rent and then return the battery pack 100 to be used by other operators on an as-needed basis. In some embodiments, the battery pack 100 may be charged via an onboard charger on a piece of power equipment and/or chore product. In some embodiments, the battery pack 100 may be charged via a charging station configured to charge the battery pack 100.

With specific reference to FIGS. 1-5, the battery pack 100 includes a front portion 102 and a back portion 104. In some embodiments, the front portion 102 and the back portion 104 may be coupled together (e.g., welded, fused, etc.) to create an outer housing 120 of the battery pack 100. More specifically, the outer housing 120 houses the one or more cell module assemblies 200. In some embodiments, the one or more cell module assemblies 200 may be coupled to the outer housing 120 using fasteners 106 (e.g., bolts, screws, nails, etc.). In some embodiments, the outer housing 120 may be made out of an aluminum material and fabricated using an aluminum die casting process. In other embodiments, the outer housing 120 may be made out of any other type of material (e.g., metal alloys, plastic, etc.).

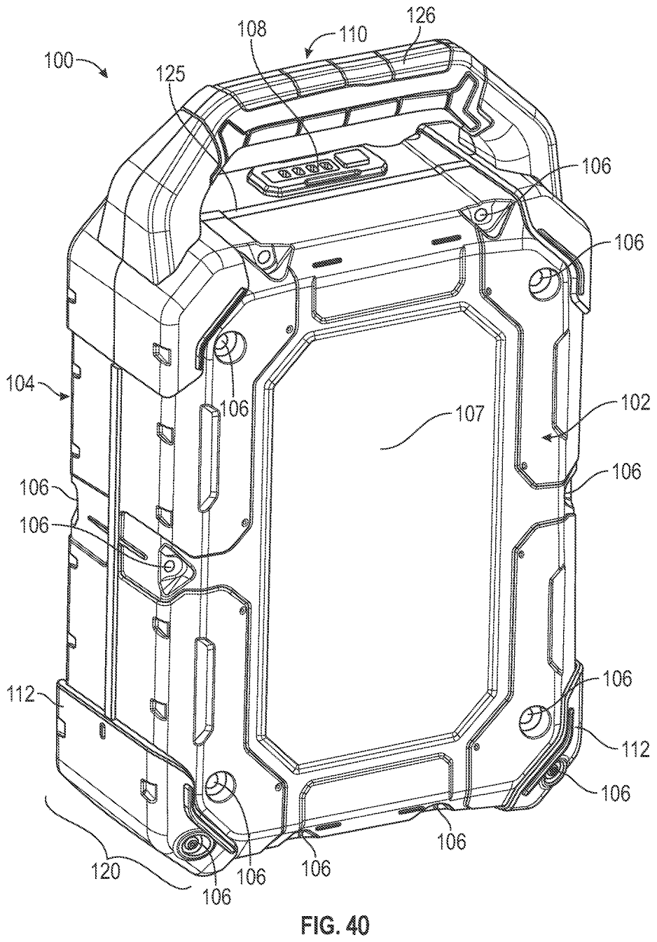

In some embodiments, battery pack 100 may include a user interface 108 configured to display an energy capacity or charge level of the battery pack 100 to a user. For example, the user interface may use LED lights that light up based on the energy remaining of the battery pack 100 (see, e.g., FIG. 6). Additionally, at least one of the LED lights may blink or flash battery fault codes. The user interface 108 can provide additional information about the battery pack 100 including condition, tool specific data, usage data, faults, etc. For example, battery indications may include, but are not limited to, charge status, faults, battery health, battery life, battery mode, unique battery identifier, link systems, etc. In the illustrated embodiment, the user interface 108 is arranged on a top side of the outer housing 120. In some embodiments, the user interface 108 is spaced from a housing interface 125 formed between the front portion 102 and the back portion 104 of the outer housing 120 (see, e.g., FIG. 40). In other words, the user interface 108 is arranged so that a seal formed along the housing interface 125 does not pass around, or otherwise engage, the user interface 108, which improves the manufacturability of the outer housing 120. In some embodiments, the user interface 108 is arranged on a base wall 107 (e.g., a front or rear face that defines a larger surface area than the walls (side walls) that depend from the front or rear face) of the front portion 102 or the rear portion 104. Arranging the user interface 108 on the base wall 107 spaces the user interface 108 from the seal formed along the housing interface 125 does not pass around, or otherwise engage, the user interface 108. Additionally, arranging the user interface 108 on the base wall 107 enables the front portion 102 and/or the rear portion 104 to be manufactured using a die casting process with a single-cavity mold (e.g., a mold without any additional structure (core, insert, etc.) that facilitates forming an opening for the user interface 108).

In some embodiments, the battery pack 100 is configured to be removable and graspable by the handle 110. In some embodiments, the handle 110 extends from the top side of the outer housing 120. In some embodiments, the handle 110 may be overmolded with one or more handle pads 126 to reduce shock and vibration within the battery pack 100 and provide a softer feel to the handle 110. Further, overmolding the handle 110 with the handle pads 126 may provide electrical insulation. In some embodiments, the handle 110 may be fabricated from a plastic materials and fastened to the outer housing 120.

In some embodiments, the outer housing 120 includes pads 112 (e.g., protectors) positioned at the each of the corners of the outer housing 120. The pads 112 are configured to provide vibration damping to the outer housing 120 and generally to the battery pack 100. In some embodiments, the handle 110 extends through a cutout or recess formed in each of the pads 112 arranged at the top side of the outer housing 120 (see, e.g., FIG. 1). In some embodiments, the pads 112 are formed from a polymer material, a thermoplastic material (e.g., TPU), or a resin material. In some embodiments, the pads 112 may cover one or more drain holes that to allow fluid (e.g., water, condensation, etc.) to drain out of the outer housing 120 through a tortuous path.

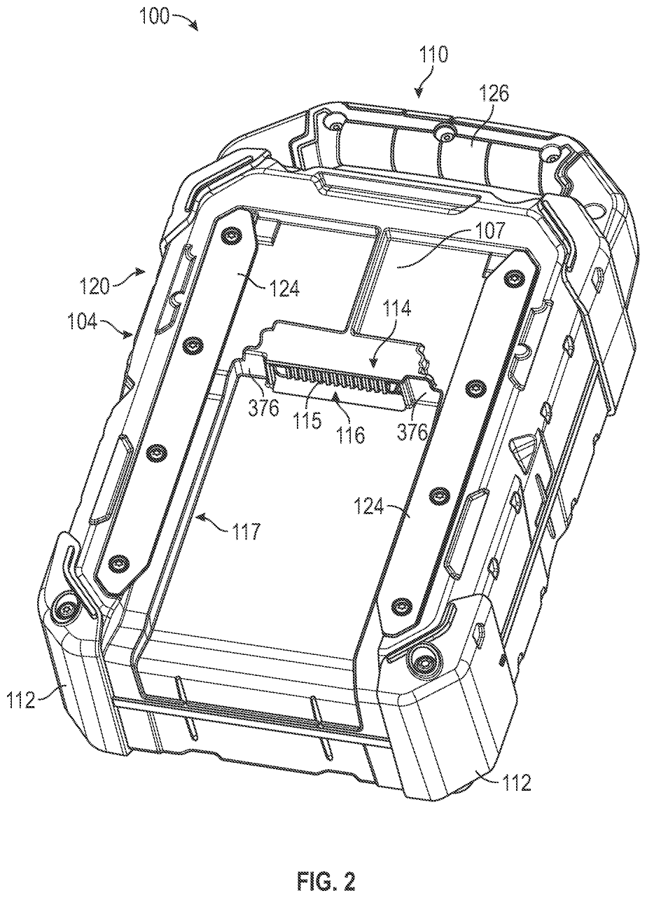

With specific reference to FIG. 2, the back portion 104 of the battery pack 100 includes a mating feature 114 positioned proximate the center of the rear portion 104. In some embodiments, the mating feature 114 may be configured to be coupled to a latch or dock assembly as described in more detail below. The mating feature 114 may include a mating feature opening 116 that is defined in the outer housing 120 and one or more ports/electrical receptacle 115 positioned therein. The electrical receptacle or connector 115 is electrically coupled to the one or more battery cells within the battery pack 100. The mating feature 114 is configured to supply power from one or more cell module assemblies 200 housed in the outer housing 120 through the ports/electrical receptacle 115 and selectively connect the battery pack 100 with at least one of a piece of power equipment and/or a charging station. In some embodiments, the mating feature 114 may further include a lock (e.g., latch, clip) configured to couple and decouple (e.g., lock and unlock) the battery pack 100 to a respective feature on a charging station and/or a piece of equipment. In some embodiments, the mating feature 114 may be configured to connect the battery pack 100 to a piece of power equipment, a chore product, and/or a charging station through a dock assembly. The outer housing 120 may define a recessed guide 117 that defines a recess in the back portion 104. The recessed guide 117 extends longitudinally along the outer housing 120 from a bottom side thereof to the mating feature 114. In general, the recessed guide 117 is configured to provide a guide or alignment feature that enables a user to easily align the pack electrical receptacle 115 with an electrical connector in a dock assembly (e.g., the dock assembly 300 described herein).

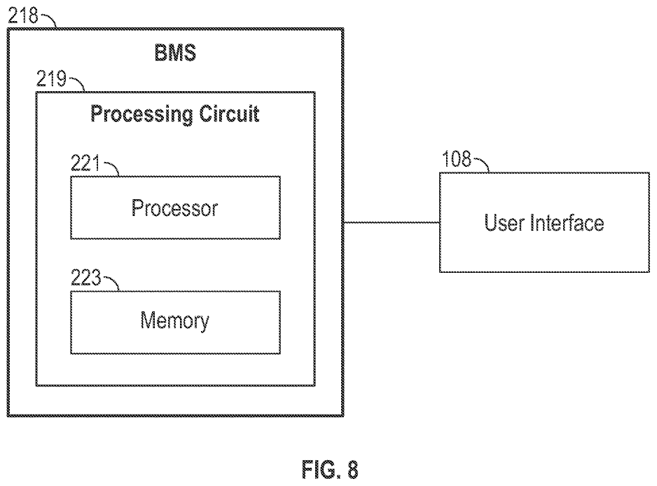

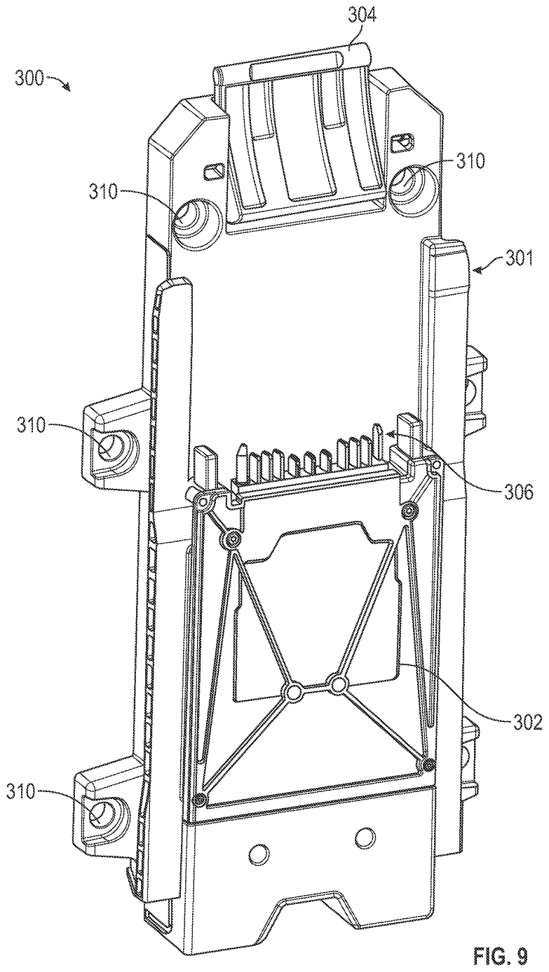

The battery pack 100 also includes two rails 124 (e.g., mounting rails) that are coupled to the outer housing 120 (e.g., on a back side thereof and laterally separated from one another). In some embodiments, the rails 124 may be fabricated from stamped steel. The rails 124 are configured to provide a coupling between the outer housing 120 and a dock assembly (e.g., the dock assembly 300), which is described in more detail below with respect to FIGS. 8 and 9. For example, each of the rails 124 include one or more mounting apertures that are spaced longitudinally along each of the respecting rails 124 through which a fastener (e.g., a screw, a bolt, or an equivalent fastener) is received. Each of the fasteners may extend through the latching assembly (e.g., the dock assembly 300) and into a respective one of the mounting apertures to couple the dock assembly to the outer housing 120. A combination of the battery pack 100 and the dock assembly 300 are referred to herein as a battery pack assembly.

Referring now to FIGS. 6 and 7, a cell module assembly 200 housed within the outer housing 120 of the battery pack 100 is shown. Generally, the cell module assembly 200 may include one or more battery cells 202 that together output power to operate a piece of power equipment. In some embodiments, the battery cells 202 may be lithium-ion battery cells. In some embodiments, the cell module assembly 200 include ninety-eight battery cells 202. In some embodiments, the ninety-eight battery cells 202 are grouped in subsets or groups of seven and connected in a parallel configuration. The groups of seven may then be connected in a series configuration to achieve a desired voltage. In some embodiments, the battery cells 202 may be electrically connected to one another using electrical connectors 240 (e.g., conducting wires) and common conductors (e.g., front collector plates 220, 222, 224, 226, 228, 230, and 232). More specifically, the cell module assembly 200 includes a sense board 204 that is wire bounded to each of the front collector plates 220, 222, 224, 226, 228, 230, and 232. The sense board 204 may be a printed circuit board (PCB) that is configured route the voltage, current, and temperature measurements associated with each of the seven sections of the cell module assembly 200. Further, the cell module assembly 200 includes wire bonding for the voltage taps and thermistors associated with the cell module assembly 200. In some embodiments, the thermistors may only be included on either the front side or the back side of the cell module assembly 200. Similarly, on the back side, the battery cells 202 may be electrically connected to one another using conducting wires and common conductors (e.g., back collector plates 242, 244, 246, 248, 250, and 252) and a sense board 201 is wire bounded to each of the back collector plates 242, 244, 246, 248, 250, and 252. The sense boards 201, 204 may be electrically coupled to a battery BMS 218 and may be configured to provide information about the battery cells 202 (e.g., voltage, current, temperature, state of charge, etc.) to the BMS 218.

The battery cells 202 may be supported by a front frame 208 and a back frame 210. The front frame 208 and the back frame 210 can each be a continuous or unitary component formed of insulating polymeric materials (e.g., polycarbonate). The front frame 208 and the back frame 210 may be generally rectangular in shape. Each of the front frame 208 and the back frame 210 may include a plurality of cylindrical protrusions 212 extending outwardly and away from the respective frames 208, 210. The cylindrical protrusions 212 each define a series of pockets that can each receive a respective end of one of the battery cells 202. In some embodiments, the front frame 208 and back frame 210 may include one or more collars positioned about their outer perimeter. For example, collars 234 and 236 may be positioned about the outer perimeter of the front frame 208 and the back frame 210, respectively. Generally, the collars 234, 236 may include a cylindrical inner wall configured to receive compression limiters. For example, collars 234 and 236 may be configured to receive compression limiter 238 (e.g., a resin-based tube or bushing). The compression limiters 238 may have a generally tubular shape.

In some embodiments, the compression limiters 238 may be defined by a height (i.e., a longitudinal length) that is larger than a height of each battery cell 202. By being taller than the battery cells 202, compressive loading experienced by either of the front frame 208 and the back frame 210 is initially diverted to the compression limiters 238 (e.g., compression limiter 238), which engages the collars (e.g., collars 234 and 236). The compression limiters 238 keep the front frame 208 and the back frame 210 at a fixed distance apart from one another, which prevents the frames from applying extreme or otherwise unwanted compressive stress to each battery cell 202 that could be caused by loading from another cell modular assembly positioned adjacent to the cell module assembly 200, for example.

With specific reference to FIG. 7, the pack electrical receptacle 115 may be configured to electrically couple the cell module assembly 200 through a power interface board 216, to a charging station or piece of power equipment. In some embodiments, the pack electrical receptacle 115 may be positioned adjacent to mating feature 114 within the outer housing 120 so that the electrical receptacle 115 are accessible to the charging station and/or piece of power equipment through the mating feature opening 116.

In some embodiments, the cell module assembly 200 includes one or more wires 254 configured to provide an electrical output (e.g., current, voltage, power, etc.) to the sense board 201. More specifically, the cell module assembly 200 may include one wire connecting each common conductor (e.g., back collector plates 242, 244, 246, 248, 250, and 252) to the electrical connector. For example, wire 254 may connect back collector plate 248 and the sense board 201 as illustrated in FIG. 7.

In some embodiments, the cell module assembly 200 may also include an electrical cord (e.g., wire harness) 214 configured to connect the power interface board 216 to BMS 218 (see, e.g., FIG. 6). The electrical cord 214 may be configured to facilitate communication between the BMS 218 and the power interface board 216 through multiple signal lines. In some embodiments, the cell module assembly 200 may include electrical connector 240 configured to connect the collector plates 220, 222, 224, 226, 228, 230, 232, 242, 244, 246, 248, 250, and 252 to the power interface board 216 so as to transfer power from the plurality of battery cells 202 to the power interface board 216. This power is then routed through a high-power switch within the power interface board 216 before reaching the electrical receptacle 115. In some embodiments, the power interface board 216 may be a printed circuit board.

Referring now to FIG. 8, the BMS 218 is described in more detail. The BMS 218 includes a processing circuit 219 having a processor 221 and memory 223. The processing circuit 219 may be structured or configured to execute or implement the instructions, commands, and/or control processes described herein with respect to the BMS 218. The depicted configuration represents the processing circuit 219 as instructions stored in non-transitory machine or computer-readable media. However, as mentioned above, this illustration is not meant to be limiting as the present disclosure contemplates other embodiments the processing circuit 219 is configured as a hardware unit. All such combinations and variations are intended to fall within the scope of the present disclosure.

The processor 221 may be one or more of a single- or multi-chip processor, a digital signal processor (DSP), an application specific integrated circuit (ASIC), a field programmable gate array (FPGA), or other programmable logic device, discrete gate or transistor logic, discrete hardware components, another type of suitable processor, or any combination thereof designed to perform the functions described herein. In this way, the processor 221 may be a microprocessor, a state machine, or other suitable processor. The processor 221 also may be implemented as a combination of computing devices, such as a combination of a DSP and a microprocessor, a plurality of microprocessors, one or more microprocessors in conjunction with a DSP core, or any other such configuration. The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure. In another configuration, the processing circuit 219 may be embodied as one or more circuitry components including, but not limited to, processing circuitry, network interfaces, peripheral devices, input devices, output devices, etc. In some embodiments, the processing circuit 219 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the processing circuit 219 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The memory 223 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory 223 may be communicably coupled to the processor 221 to provide computer code or instructions to the processor 221 for executing at least some of the processes described herein. Moreover, the memory 223 may be or include tangible, non-transient volatile memory or non-volatile memory. Accordingly, the memory 223 may include database components, object code components, script components, or any other type of information structure for supporting the various activities and information structures described herein.

The BMS 218 is coupled to the user interface 108 and is configured to provide information to the user interface 108. For example, the BMS 218 may determine the state of charge battery pack 100 and communicate this information to the user interface 108. The user interface 108 then communicates (e.g., visibly and/or audibly) this information to the user.

As described herein, the cell module assembly 200 may in communication with the battery management system (BMS) 218. In some embodiments, the BMS 218 may be positioned at the top of the cell module assembly 200. In other embodiments, the BMS 218 may be included in any location within the cell module assembly 200. In some embodiments, the BMS 218 may be electrically coupled to one or more of the common collector plates (e.g., front collector plates 220, 222, 224, 226, 228, 230, and 232 and/or back collector plates 242, 244, 246, 248, 250, and 252) through the sense board 201 and the sense board 204. The electrically connections between the BMS 218 and the front collector plates 220, 222, 224, 226, 228, 230, and 232 and the back collector plates 242, 244, 246, 248, 250, and 252 allows for a voltage reading across all of the battery cells 202. The BMS 218 is configured to manage the power output of the battery cells 152. The BMS 218 may be configured to allow the battery cells 202 to provide full power output to pack electrical connectors 115 to supply power to power equipment with which the battery pack 100 is connected. In some embodiments, the BMS 218 may allow battery cells 202 to be charged when battery pack 100 is connected to charging stations. The BMS 218 may also be configured to selectively shut off power output from battery cells 202 to pack electrical connector 115, as described herein.

In some embodiments, the BMS 218 may be a pulse width modulation (PWM) type controller configured to control one or more switches (e.g., MOSFETS, transistors, etc.) to direct the current output of the battery pack 100. For example, the BMS may control six parallel MOSFETS within the power interface board 216 switching at a frequency of 20-30 kilo-hertz to control a current output from the battery pack 100. In some embodiments, the PWM controller not only controls the current output from the power interface board 216, but also the current input into the battery pack 100 through the power interface board 216. In other words, the PWM type controller controls a bi-directional current in and out of the battery pack 100. A bi-directional current may enable the PWM type controller to diagnose potential errors within the battery pack 100. For example, if a fuse or wire was to become corrupted (e.g., corroded, blown, etc.) and the battery pack was no longer able to produce a current, the PWM type controller would allow current to flow into the battery pack 100 from an external source (e.g., a piece of power equipment, another removable battery pack, a charging station). The PWM type controller may then be able to use the current flowing into the battery pack to diagnose the error within the battery pack. In some embodiments, the BMS may not use PWM to control the one or more switching elements.

In some embodiments, the BMS 218 may be configured to receive information from a piece of power equipment that may be used to protect the battery pack 100 from harming itself or the piece of power equipment. For example, a piece of power equipment may only have the capacity to receive 2 kilo-watts of power from a power source. In this case, this equipment power limit would be received by the BMS 218 which would ensure that the power output of the battery pack 100 would not exceed this power limit. In some embodiments, the BMS may receive this information via digital inputs, serial data (e.g., CAN), and/or wireless (e.g., Bluetooth, Wi-Fi, etc.) means.

In some embodiments, the BMS 218 may also be configured to record and store data regarding usage, cycles, power level, rental duration, etc., of the battery pack 100. The BMS 218 may also be configured to wirelessly connect to a remote database, a remote network, or a remote device, according to some embodiments. In some embodiments, BMS 218 may further be configured to control user interface 108. As noted above, the user interface 108 may display information to the operator, such as battery level, error messages, etc.

The user interface 108 may then use LED lights 206 and a button 207 to display a variety of battery information including but not limited to a state of charge, an energy remaining, and an operating range. More specifically, in some embodiments, the user interface 108 may include four LED lights 206 that may be turned on or off depending on the energy remaining. For example, each of the LED lights may be turned off or on for each quarter portion of energy that is either lost or gained by the battery pack. In some embodiments, the user interface 108 also includes a fifth LED light 209 that is configured to display an error message or indicate a wireless connectivity status. In some embodiments, the button 207 may be engaged by user to illuminate user interface 108 (e.g., the LED lights 206). The outer housing 120 may include an opening near the top of the battery pack 100 below the handle 110 that the user interface 108 may pass through so that it is externally visible.

### Dock Connector

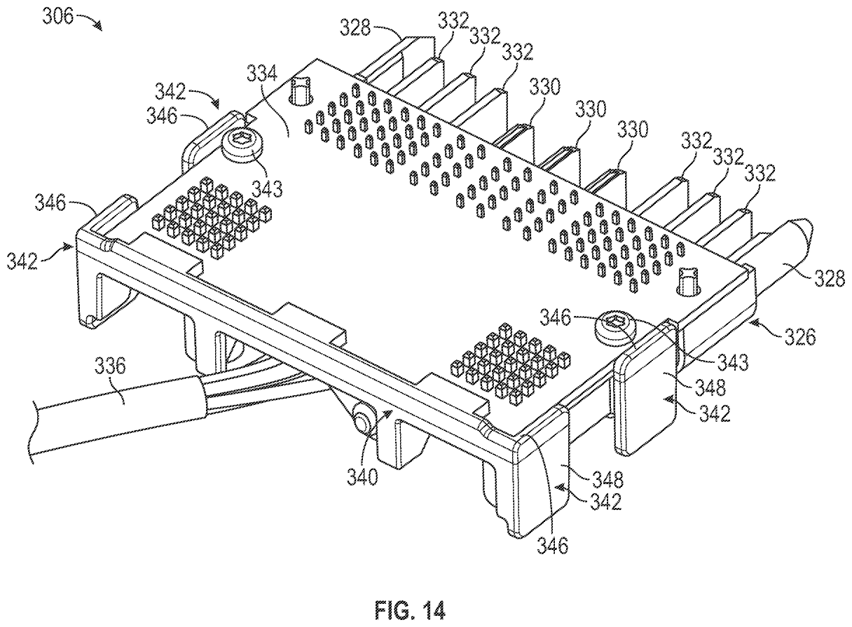

Referring now to FIGS. 9-12, a latch or dock assembly 300 for coupling the battery pack 100 to a receptacle (e.g., a piece of power equipment, charging station, etc.) is shown. The dock assembly 300 may be coupled to a receptacle by fasteners through fastener holes 310 formed in a body 301. The dock assembly 300 may also include an electrical wiring cover 302 that is configured to cover and protect electrical wires included in the dock assembly 300. The dock assembly 300 may include a lever 304 that when pivoted as a result of pulling or displacing the lever 304 may cause the battery pack 100 to slide along the lever 304 to couple with the dock assembly 300 by locking into a recess 318 (see, e.g., FIG. 14). More specifically, the battery pack 100 may couple to a receptacle electrical connector 306 with the pack electrical receptacle 115. In some embodiments, the pins of the electrical connector 306 may vary in height based on their function. For example, the electrical connector 306 includes a connector body 326 from which alignment pins 328, communication pins 330, and power pins 332 extend. In some embodiments, the alignment pins 328 include two pins arranged at laterally outward ends of the connector body 326 that extend a furthest distance from the connector body 326 relative to the communication pins 330 and the power pins 332. In some embodiments, the power pins 332 are arranged laterally inwardly from the alignment pins 328 but laterally outwardly relative to the communication pins 330. In other words, the communication pins 330 are arranged laterally between the power pins 332. The power pins 332 extend from a connector body 326 a further distance than the communication pins 330 but a shorter distance than the alignment pins 328. In this way, for example, as the connector 306 is disconnected from the electrical receptacle 115, the communication pins 330 can disconnect while the power pins 332 remain connected. This allows the BMS 218 to disconnect power to avoid arcing as the battery pack 100 is removed from the dock assembly 300.

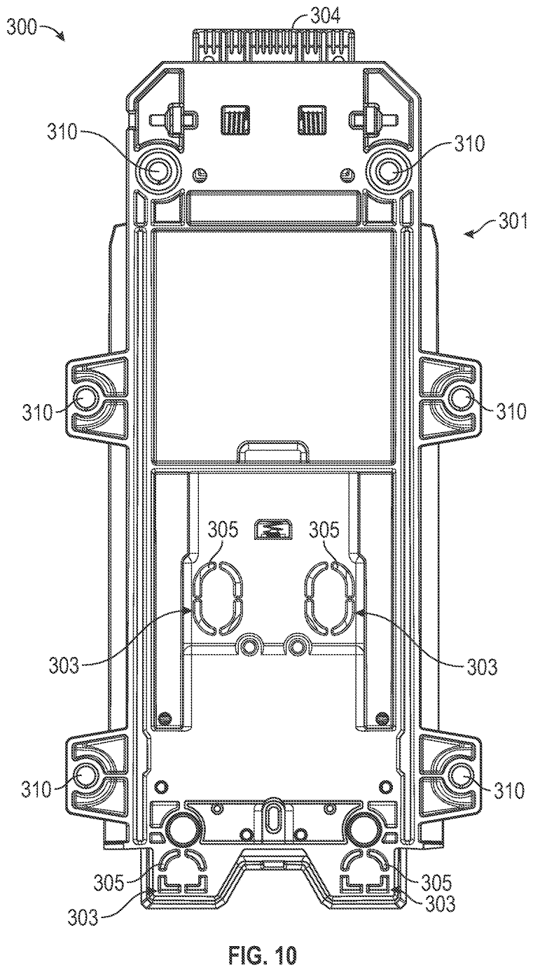

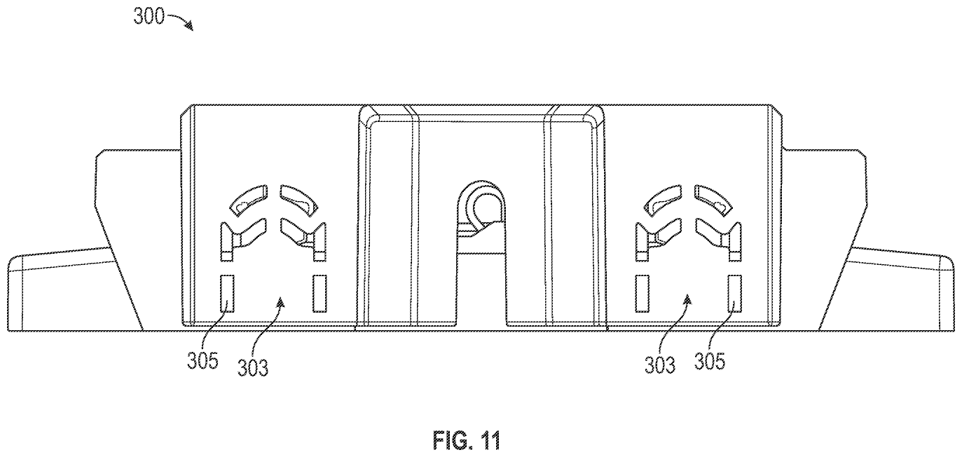

Referring now to FIGS. 10 and 11, the dock assembly 300 includes a body 301 that defines a plurality of punch outs 303. Each of the punch outs 303 is formed by a plurality of cutouts 305 that extend in a pattern, with solid material formed between each adjacent cutout 305. The solid material between each cutout 305 may be selectively removed by a user to form an aperture that extends through the body 301 through which wiring may be routed. In the illustrated embodiments, the body 301 includes six punch outs 303 that are spaced from one another in at least two directions (e.g., vertically and horizontally from the perspective of FIG. 9). For example, the body 301 may include four punch outs 303 arranged in a back side of the body 301, with two being formed adjacent to a bottom side of the body 301 (e.g., a lower side from the perspective of FIG. 10) and two being formed in a center portion of the body 301. The pairs of punch outs 303 formed in the back side of the body 301 may be longitudinally separated from one another. The body 301 may further include two punch outs 303 formed in a bottom surface of the body 301 (see, e.g., FIG. 11). For example, the punch outs 303 formed in the bottom surface may be arranged perpendicularly to the punch outs 303 formed in the back side, which enables a user to selective form apertures for routing wiring in various directions through the body 301. In some embodiments, the punch outs 303 arranged in the bottom side are formed in a separate component (e.g., a bottom cover) that is coupled to the body 301.

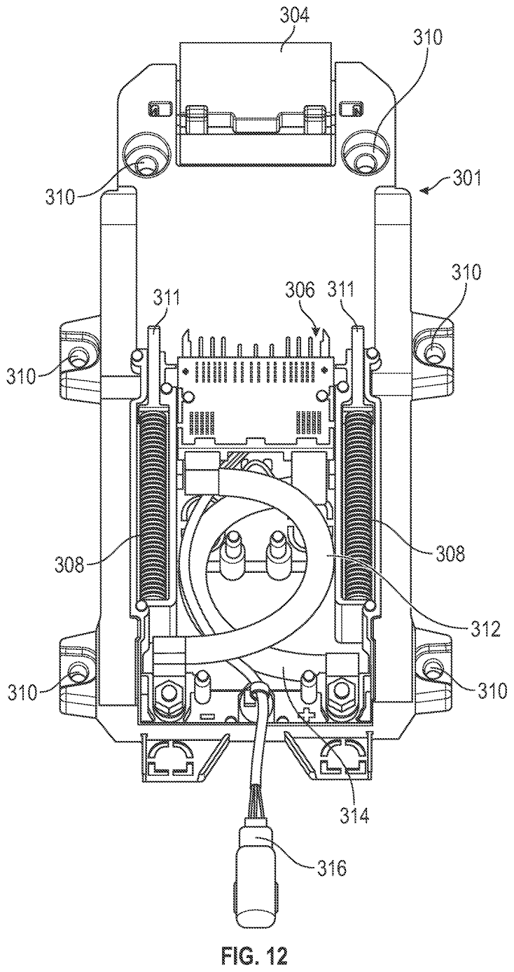

Referring now to FIG. 12, a perspective view of the dock assembly 300 with the electrical wiring cover 302 removed is shown. In some embodiments, the dock assembly 300 may include springs 308 that assist with coupling the electrical connector 306 with pack electrical receptacle 115. More specifically, each of the springs 308 is coupled an ejector pin 311 that is configured to engage the battery pack 100 (e.g., a portion of the mating feature 114 and/or the outer housing 120) and partially disconnect the electrical connector 306 from the electrical receptacle 115.

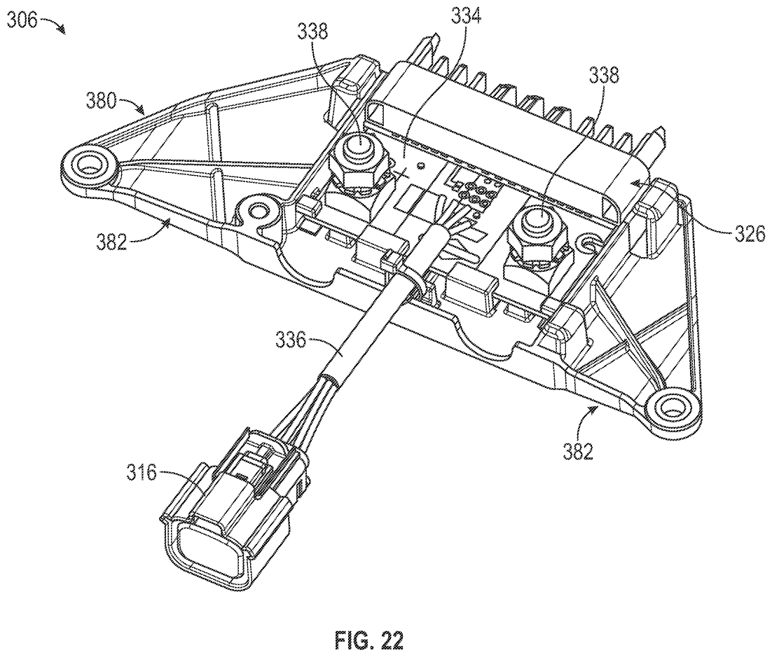

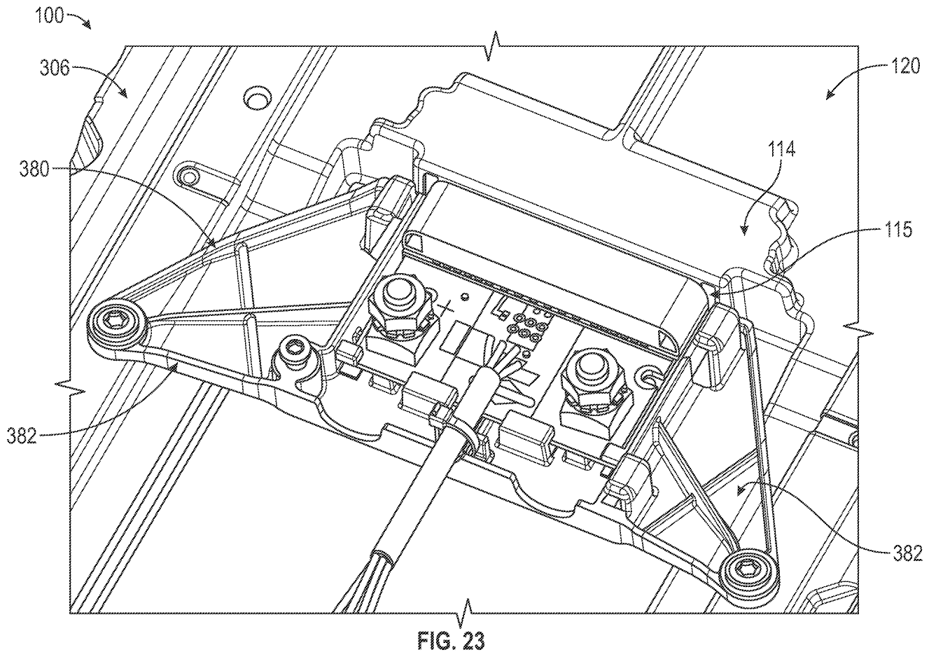

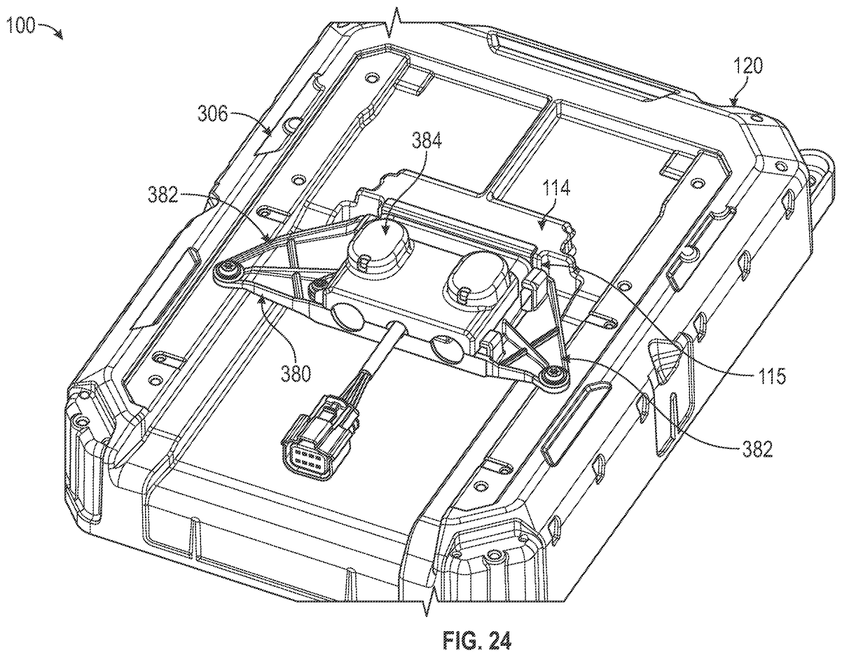

In some embodiments, the dock assembly 300 includes a positive electrical wire 314 and a negative electrical wire 312. In some embodiments, the dock assembly 300 includes an outlet connector 316 that is configured to connect the electrical connector 306 to the piece of power equipment and/or charging station (e.g., connecting to a CAN network). The dock assembly 300 is configured to provide customizable options to route the electrical wires 312 and 314 and electrical connector 306 to couple the battery pack 100 and the dock assembly 300 in one of multiple allowable configurations. For example, in some embodiments, an equipment manufacturer may wish to rigidly attach the battery pack 100 to the dock assembly 300. In this case, permanent wiring may be installed and an adapter implemented to enclose the lose wires (e.g., the outlet connector 316) within the dock assembly 300 (see, e.g., FIGS. 22-24). In this case, the handle 110 and the pads 112 may not be included in the battery pack 100 (see, e.g., FIGS. 22-24). As another example, an equipment manufacturer may wish to flexibly attach the battery pack 100 to the dock assembly 300 as described herein.

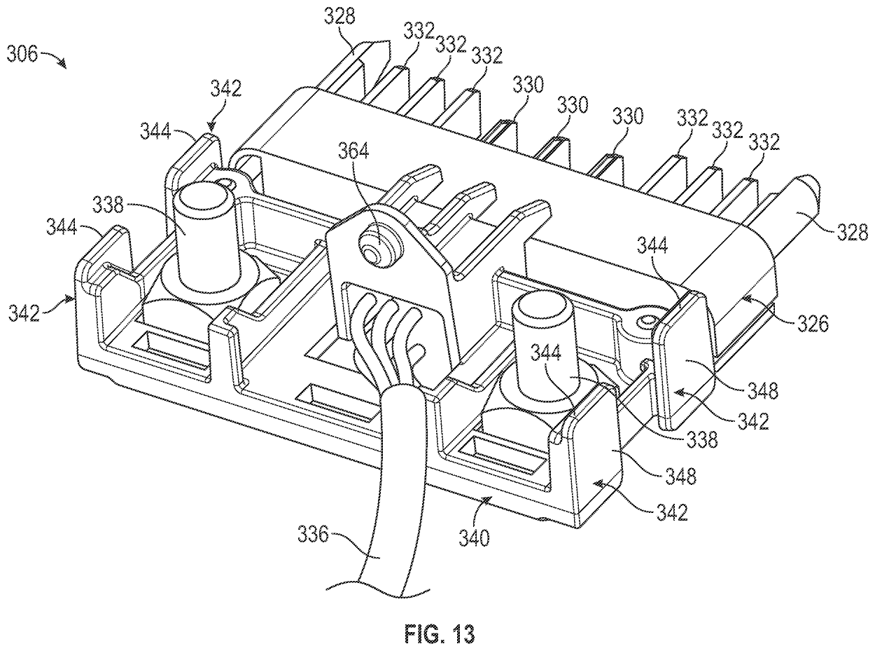

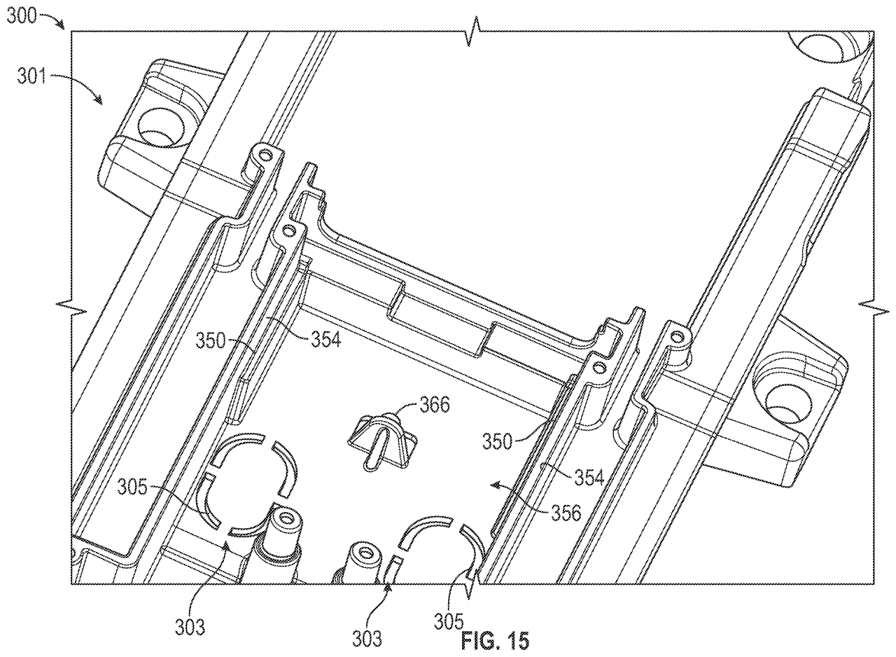

Referring to FIGS. 13-17, the electrical connector 306 includes the connector body 326 from which the alignment pins 328, communication pins 330, and power pins 332 extend. The electrical connector 306 further includes a printed circuit board (PCB) 334 in electrical communication with the communication pins 330, the power pins 332, a connector cable 336, which connects to the outlet connector 316, and electrical terminals 338, which are configured to receive electrical power from the cell module assemblies 200 and connect to the wires 312, 314. The connector body 326 and the PCB 334 (and the components coupled to the PCB 334) are coupled to a floating carrier 340. In some embodiments, one or more fasteners 343 (e.g., screws) extend through the PCB 334 and into the floating carrier 340 to couple the PCB 334 to the floating carrier 340. In general, the floating carrier 340 is arranged between the body 301 and the cover 302 so that the electrical connector 306 is arranged in a floating arrangement. That is, the electrical connector 306 is allowed to move in any direction relative to the body 301 and the cover 302, which aids in aligning the electrical connector 306 with the electrical receptacle 115 during installation of the battery pack 100 on the dock assembly 300.

In some embodiments, the floating carrier 340 includes one or more tabs 342 that are arranged on laterally outer edges of the floating carrier 340. Each of the tabs 342 includes a first floating interface surface 344, a second floating interface surface 346, and a third floating interface surface 348. The first floating interface surface 344 and the second floating interface surface 346 are arranged on opposing ends of each of the respective tabs 342, and the third floating interface surface 348 extends between the first floating interface surface 344 and the second floating interface surface 346 at a laterally outer side of each of the respective tabs 342. When the dock assembly 300 is assembled, the first floating interface surfaces 344 face (e.g., a normal extending outwardly from the surface points toward) a dock interface surface 350 of the body 301, the second floating interface surfaces 346 face a cover interface surface 352 of the cover 302, and the third floating interface surfaces 348 face a lateral interface surface 354 of the body 301. In some embodiments, the dock interface surfaces 350, the cover interface surfaces 352, and the lateral interface surfaces 354 define a connector cavity 356 within which the floating carrier 340 is arranged in the floating arrangement. That is, a gap can be formed between the first floating interface surfaces 344 and the dock interface surfaces 350, between the second floating interface surfaces 346 the cover interface surfaces 352, and the third floating interface surfaces 348 and the lateral interface surfaces 354. In this way, for example, the floating carrier 340 is capable of moving in any direction within the connector cavity 356, which allows the electrical connector 306 to move relative to the electrical receptacle 115, which is fixed in the battery pack 100, and align the electrical connector 306 with the electrical receptacle 115.

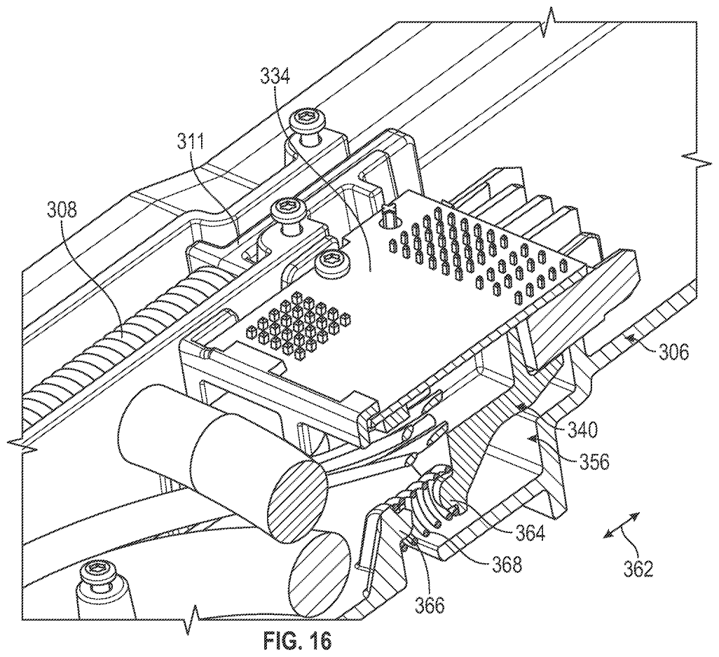

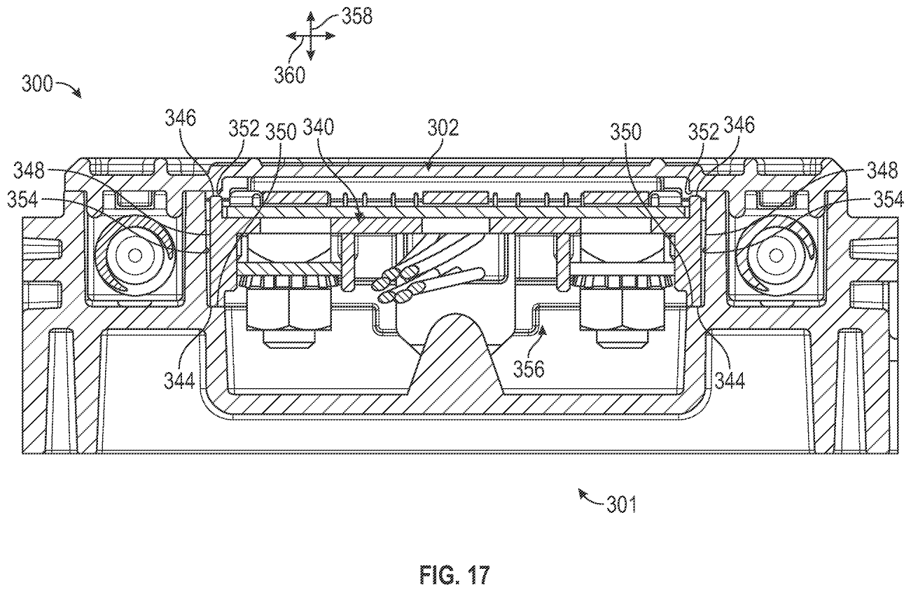

In some embodiments, the gaps formed between the first floating interface surfaces 344 and the dock interface surfaces 350 and between the second floating interface surfaces 346 the cover interface surfaces 352 enable movement of the floating carrier 340 along a first axis 358 (e.g., an up-and-right direction from the perspective of FIG. 17). The gap formed between the third floating interface surfaces 348 and the lateral interface surfaces 354 enables movement of the floating carrier 340 along a second axis 360 (e.g., a left-to-right direction from the perspective of FIG. 17) arranged perpendicular to the first axis 358. In addition to the movement along the first axis 358 and the second axis 360, the floating carrier 340 free to move along a third axis 362 (see, e.g., FIG. 16) due to an elastic coupling between the floating carrier 340 and the body 301 of the dock assembly 300. The third axis 362 is arranged perpendicular to both the first axis 358 and the second axis 360 (e.g., an into-and-out-of-the-page direction from the perspective of FIG. 17). For example, the floating carrier 340 may include a carrier protrusion 364 and the body 301 includes a corresponding body protrusion 366, and a spring 368 is biased between the carrier protrusion 364 and the body protrusion 366. The spring 368 enables the floating carrier 340 to move along the third axis 362 in response to the battery pack 100 being installed on the dock assembly 300. In some embodiments, the only coupling between the floating carrier 340 and the body 301 is the spring 368, which allows the floating carrier 340 to float (e.g., move along any of the first axis 358, the second axis 360, and/or the third axis 362) and provides a biasing force on the electrical connector 306 along the third axis 362 that acts to initiate and maintain a full connection between the electrical connector 306 and the electrical receptacle 115.

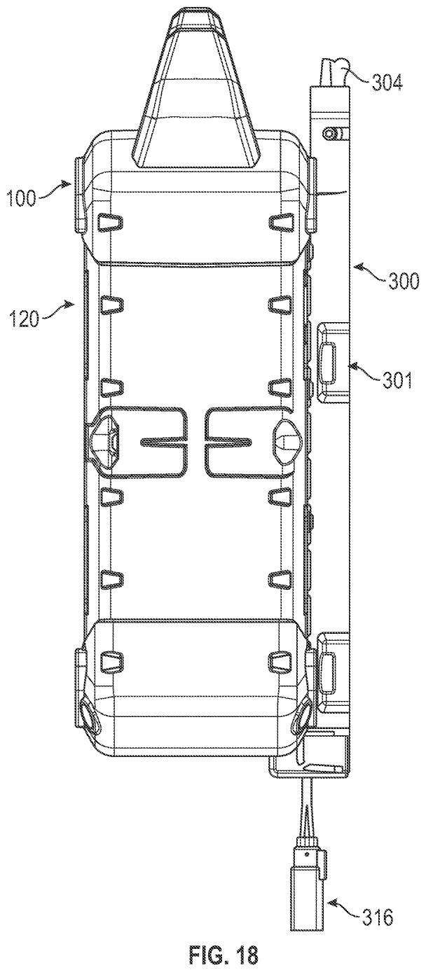

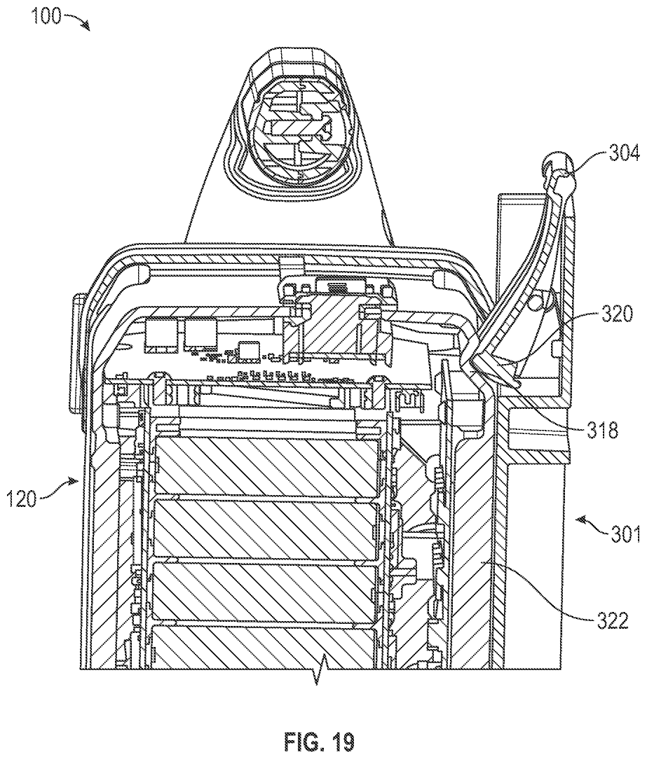

Referring now to FIGS. 18 and 19, a side view of the dock assembly 300 coupled to the battery pack 100 is shown according to an exemplary embodiment. The outlet connector 316 electrically connects the battery pack 100 and the dock assembly 300 to a piece of power equipment and/or charging station (not shown). As described herein, the outer housing 120 includes a recess 318 that interacts with the lever 304 (see, e.g., FIG. 14). For example, the lever 304 is pivotally coupled to the body 301 so that a latching portion 320 (e.g., a protruding bulb) is configured to pivotally move relative to the body 301 in response to a user displacing (e.g., pulling on) the lever 304. That is, the latching portion 320 may move toward and away from the body 301 in response to a user displacing the lever 304. In some embodiments, the lever 304 is spring-biased into a first or locked position (see, e.g., FIG. 14) where the latching portion 320 extends outwardly from the body 301.

In general, the lever 304 is configured to securely couple the battery pack 100 to the dock assembly 300 so that the battery pack 100 is prevented from displacing relative to the dock assembly 300. During installation of the battery pack 100 onto the dock assembly 300, a user may arrange the electrical connector 306 and/or the wiring cover 302 within the recessed guide 117 of the outer housing 120 to ensure alignment between the pack electrical receptacle 115 and the electrical connector 306. Arranging the electrical connector 306 within the recessed guide 117 brings the outer housing 120 of the battery pack 100 into engagement with the lever 304. Specifically, the latching portion 320 of the lever 304 engages an outer surface 322 of the outer housing 120. The engagement with the outer surface 322 pivots the latching portion 320 of the lever 304 in an inward direction (e.g., to the right, or counterclockwise, from the perspective of FIG. 14) against the spring-bias of the lever 304. The battery pack 100 is then displaced relative to the dock assembly 300 (e.g., moved downward from the perspective of FIG. 14) until the latching portion 320 aligns with the recess 318 formed in the outer housing 120. Because the lever 304 is spring-biased, once the latching portion 320 aligns with the recess 318, the latching portion 320 automatically pivots into the recess 318 upon alignment between the two components. With the latching portion 320 arranged within and engaged with the recess 318, the battery pack 100 is prevented from being displaced (e.g., pulled upward or further pushed downward) relative to the dock assembly 300, and the amount of displacement between the battery pack 100 and the dock assembly 300 ensures that the pack electrical receptacle 115 electrically couples to the electrical connector 306 either simultaneously with or prior to the latching portion 320 engaging with the recess 318. Further, the spring 368 ensures that the electrical connector 306 is forced into and maintained in connection with the electrical receptacle 115 after the lever 304 pivots into the recess 318 to lock the battery pack 100 relative to the dock assembly 300.

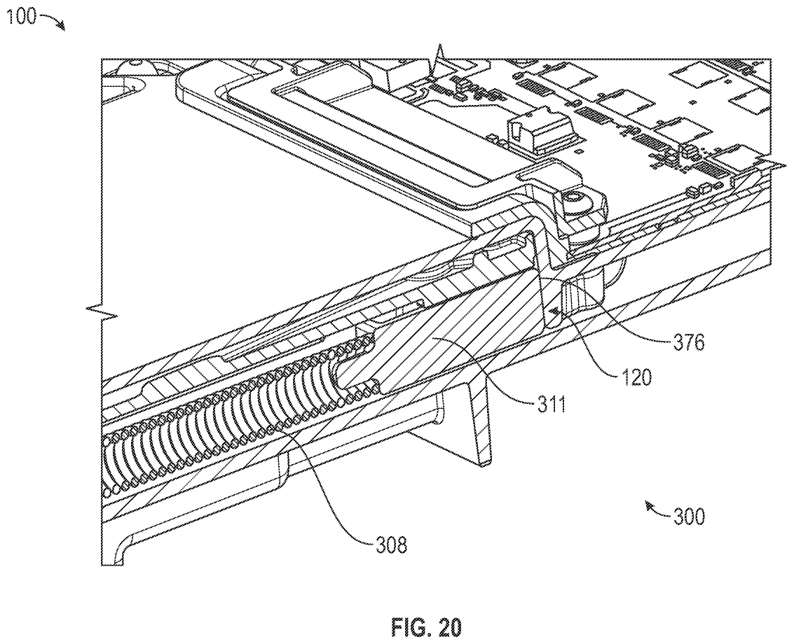

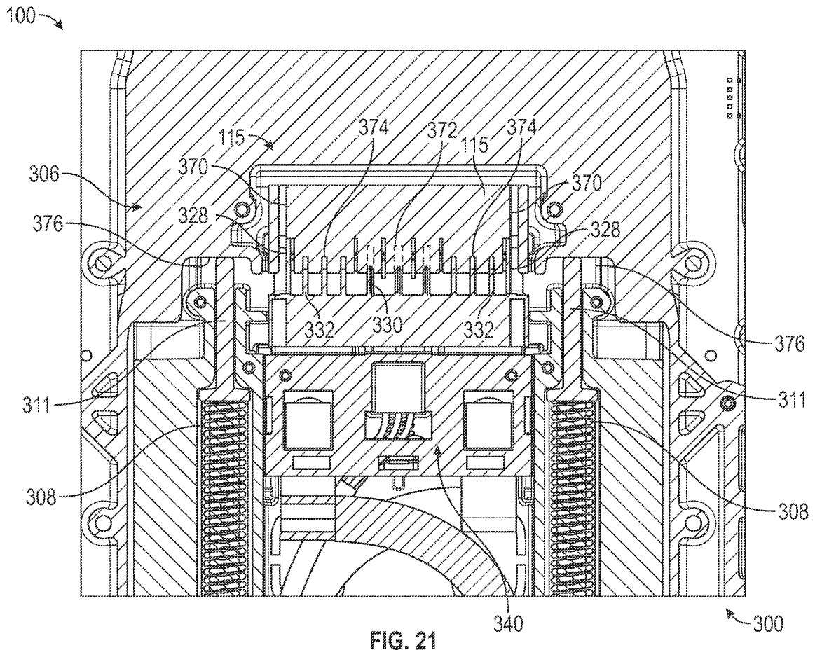

Turning to FIGS. 20 and 21, in some embodiments, as the battery pack 100 is installed onto the dock assembly 300, the floating carrier 340 moves relative to the fixed electrical receptacle 115 to align the alignment pins 328 with a corresponding set of alignment receptacles/ports 370 within the electrical receptacle 115 (see, e.g., FIG. 21). With the alignment pins 328 received within the corresponding alignment ports 370, the communication pins 330 and the power pins 332 are aligned with the corresponding communication receptacles/ports 372 and power receptacles/ports 374, respectively, within the electrical receptacle 115 (see, e.g., FIG. 21). When the lever 304 is pivoted into the recess 318 and the battery pack 100 is locked to the dock assembly 300, the spring 368 ensures that a full connection/engagement is made and maintained between the communication pins 330 and the corresponding communication ports 372, and between and the power pins 332 and the corresponding power ports 374. During operation of the power equipment on which the battery pack 100 is installed, the battery pack 100 and the dock assembly 300 coupled thereto may experience vibration and shock. Due to the floating arrangement of the floating carrier 340, the electrical connector 306 will follow the movements of the fixed electrical receptacle 115 (i.e., movement of the battery pack 100 relative to the dock assembly 300) to minimize wear on connection surfaces (fretting).

When a user removes the battery pack 100 from the dock assembly 300, the user may displace (e.g., pivot) the lever 304 so that the latching portion 320 pivots out of the recess 318, which unlocks the battery pack 100 from the dock assembly 300 (e.g., the outer housing 120 is allowed to move relative to the body 301). In some embodiments, the ejector pins 311 and the springs 308 coupled thereto are configured to bias the outer housing 120 so that the electrical receptacle 115 moves to a partially removed position (see, e.g., FIG. 21). In some embodiments, each of the ejector pins 311 is configured to engage an outer surface 376 of the outer housing 120 to move the outer housing 120 to the partially removed position. In the partially removed position, the communication pins 330 are removed or disengaged from the communication ports 372 but the power pins 332 are still inserted within or engaged with the power ports 374. This allows the BMS 218 to disconnect power to the electrical terminals 338, prior to the power pins 332 being disengaged, to avoid arcing when the battery pack 100 is fully removed and the power pins 332 disengage from the power ports 374.

Turning to FIGS. 22-24, in some embodiments, the battery pack 100 may be permanently mounted to the power equipment, rather than the dock assembly 300 (i.e., the dock assembly 300 is not included on the power equipment). In these embodiments, the electrical connector 306 is permanently mounted to the outer housing 120 of the battery pack 100 by a permanent connector bracket 380, rather than the floating carrier 340. The permanent connector bracket 380 includes a pair of opposing wings 382 that extend laterally outwardly from the electrical connector 306 and are fastened to the outer housing 120, for example, by a fastener in the form of a bolt or a screw. A terminal cover 384 is coupled to the permanent connector bracket 380 to cover the electrical terminals 338. As illustrated in FIGS. 22-24, in the permanently-mounted configurations, the battery pack 100 may not include the handle 110, the pads 112, and/or the rails 124.

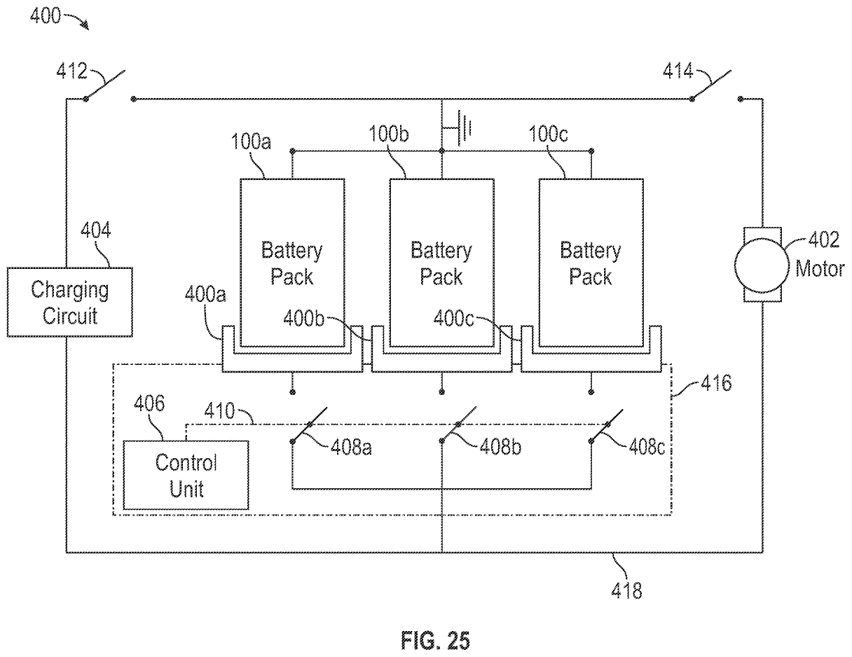

Referring now to FIG. 25, a schematic diagram for controlling the operation of one or more removable battery packs 100a-100c connected in a parallel configuration is shown, according to an exemplary embodiment. The removable battery packs 100a-100c may include all the components of the battery pack 100 described above. FIG. 25 illustrates the electrical connections utilized to power one or more motors 402 and for recharging the battery packs 100a-100c utilizing a charging circuit 404. In the embodiment shown in FIG. 25, a control unit 406, which could be one of many different types of microprocessors or microcontrollers, is used to control the state of three individual switching elements 408a-408c. The state of each of the individual switching elements 408a-408c is controlled by the control unit 406 through a control line 410. Although a single control line 410 is shown in FIG. 25, it should be understood that multiple control lines could be utilized or a single control line 410 could be utilized while operating within the scope of the present disclosure. In addition, the switching elements 408a-408c could be either a single element (MOSFET, IGBT, transistor, relay, etc.) or could be a combination to two switching devices.

In one contemplated embodiment of the present disclosure, each of the switching elements 408 is a high current MOSFET that can transition between an open and closed position through control commands from the control unit 406. Although a MOSFET is described in one embodiment as the switching element 408, it should be understood that different types of switching elements could be utilized while operating within the scope of the present disclosure. Although the switching element 408 is displayed to be external to the battery pack 100, in some embodiments, the switching element may be internal to the battery pack 100.

As illustrated in FIG. 25, the first switch 408a is connected to the electrical contacts contained within the battery slot 400a to provide a connection between the battery pack 100a and a common power bus 418. In some embodiments, the ground is connected to the battery at all times for proper operation of the battery pack. Switch 408b is positioned between the contacts in the battery slot 400b and ground to control the charging and discharging of the battery pack 100b. Finally, switch 408c is positioned in electrical connection with the battery slot 400c which receives the battery pack 100c. The control unit 406 is operable to selectively open and close each of the individual switches 408 as desired to control both the charging and discharging of the battery packs 100. Since the switches 408 are contemplated as being MOSFETS, the control unit 406 can open and close the switches 408 at rapid rates to selectively control the rate of charge from the charging circuit 404 or discharge to the motor 402.

A charging switch 412 is moved to the closed position during charging while the discharge switch 414 would be moved to the open position. Likewise, during discharge of the battery packs, the discharge switch 414 is moved to the closed position and the charging switch 412 is moved to the open position. The control unit 406 can also control the position of the switches 412, 414 to ensure that both of the switches 412, 414 are not in the closed position at the same time to prevent the charging circuit 404 from directly operating the electric motor 402.

Although the control unit 406 is shown as being contained within a battery tray 416, it should be understood that the control unit 406 could be located at other positions or locations, including inside one of the battery packs 100. However, positioning the control unit 406 within the battery tray 416 will allow the same control unit 406 to control the switches 408 during both charging and discharging of the battery packs 100.

In addition to controlling the position of the switches 408, the control unit 406 may also be configured to monitor the state of charge or energy remaining on each of the battery packs 100 in a conventional manner. An exemplary method of monitoring the state of charge on each of the battery packs 100 is to monitor the voltage of the respective battery packs utilizing a voltage sensor. In an illustrative example, the maximum state of charge of the battery packs will be 82 volts. When the output of the battery pack 100 falls to 80 volts, the battery pack will be at 80% charge. However, the determination of state of charge based on battery pack voltage is dependent on battery types, battery configurations, and other parameters. Accordingly, state of charge may be determined based on the battery pack voltage, and other relevant factors associated with the battery pack. Percent of maximum change will be used in the following exemplary discussion to illustrate the charging and discharging control by the control unit 406. By monitoring the state of charge on each of the individual battery packs 100, the control unit 406 would be able to selectively control the discharge rate of each of the individual battery packs 100a-100c as well as control the rate of charge of the individual battery packs 100a-100c. In this manner, it is contemplated that the control unit 406 would be able to maintain each of the battery packs 100a-100c at the same state of charge during both the discharge and charging cycles. In other embodiments, other methods of monitoring the battery packs remaining energy and/or state of charge may be used.

In the embodiment shown in FIG. 25, each of the switches 408a-408c is a MOSFET that is positioned within the battery tray 416. However, it is contemplated that the MOSFET switch 408 could be moved into the individual battery pack 100 and be in communication with the control unit 406 through the individual battery slots 400. If the MOSFET switching element 408 were located within the battery pack 100 instead of within the battery tray 416, the MOSFET switch 408 would always move with the battery pack 100 rather than remaining within the battery tray 416. In another embodiment, both the battery pack 100 and the battery tray 416 could include switching elements. In yet another embodiment, the battery tray 416 may include a controllable fuse (e.g., a switching device such as a MOSFET, transistor, etc.) configured to prevent a live terminal in an empty battery slot. For example, if battery slot 400a is empty, the controllable fuse would disconnect the battery slot 400a from the common power bus.

Although the embodiments shown in FIG. 25 illustrate three battery packs connected in parallel, it is contemplated that additional battery packs could be utilized while operating within the scope of the present disclosure. For example, if a larger piece of power equipment (e.g., a riding lawn mower) was to be powered by the removable battery packs, one or more additional removable battery packs could be connected in the parallel arrangement to increase the output power of the combined unit. Adding an additional battery pack in parallel with the three battery packs shown in FIG. 25 will both increase the run-time and will slightly increase the voltage created by the parallel connected battery packs. The addition of battery packs in parallel will also increase the available power (increased current availability), which will increase runtime. The additional battery packs connected in parallel will also allow the output voltage to remain at the desired level for a longer period of time. Before allowing any additional removable packs to join the common bus, the control unit 406 might analyze one or more battery characteristics (e.g., open circuit voltage, energy remaining, etc.) to determine whether the battery pack would be able to safely join the common bus.

### Pack Connector/Receptacle

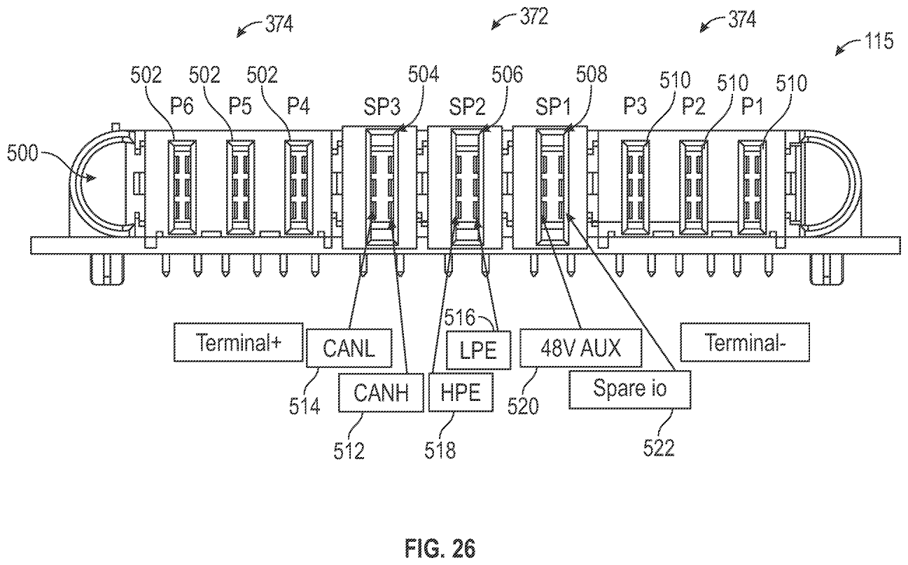

Referring now to FIG. 26, the receptacle or connector 115 of the battery pack 100 is shown, according to some embodiments. In general, the connector 115 includes a plurality of ports 500 arranged in a row that are configured to receive the pins 330, 332 on the electrical connector 306 (e.g., on the dock assembly 300 or on the permanently-installed configuration). In the illustrated embodiments, the connector 115 includes nine ports 500. Starting from the left (e.g., from the perspective of FIG. 26) or a first side of the connector 115, the connector 115 includes three positive battery ports 502 (e.g., a positive side of the power ports 374). The positive battery ports 502 may each include one or more connections (e.g., blades, terminals, pins, plates, etc.) that are each connected to output the voltage from the positive side of the battery cells 202 (e.g., to the corresponding collector plates). In some embodiments, the connector 115 may include more or less than three positive ports 502.

The fourth port from the left is a CAN port 504 (e.g., one of the communication ports 372). The CAN port 504 is a split pin port. A split pin port enables two separate connections (e.g., two blades, terminals, pins, plates, etc.), one on the left and one on the right, as shown in FIG. 26. The fifth port from the left, or the middle port of the connector 115, is an enable port 506. The enable port 506 is a split-pin port. The sixth port from the left is an auxiliary power and spare I/O port 508. The auxiliary power and spare I/O port 508 is a split-pin port. The final three ports, or the three ports adjacent to the right or second side of the connector 115, are negative battery terminal ports 510 (e.g., a negative side of the power ports 374). The negative battery ports 510 may each include one or more connections (e.g., blades, terminals, pins, plates, etc.) are each connected to output the voltage from the negative side of the battery cells 202. In some embodiments, the connector 115 may include more or less than three negative battery ports 510.

The CAN port 504 includes a CAN positive terminal 512 (e.g., CAN high, CANH, etc.) and a CAN negative terminal 514 (e.g., CAN low, CANL, etc.). In general, the CAN port 504 may enable the battery pack 100 to communicate with equipment (e.g., outdoor power equipment, chore products, or a controller, etc.) over a Controller Area Network (CAN) bus. For example, the electronic control unit (ECU) of an electronic control unit (ECU) of an outdoor power equipment or a chore product may communicate with the BMS 218 of the battery pack 100 via a CAN bus connected between the ECU and the CAN port 504 of the battery pack 100.

The enable port 506 includes a low-power enable terminal 516 and a high-power enable terminal 518. The auxiliary power and spare I/O port 508 includes an auxiliary power terminal 520 and an input/output (I/O) terminal 522. In general, the three ports between the positive battery ports 502 and the negative battery ports 510 enable six separate signals to be communicated to the connector 115 due to the split pin design of the CAN port 504, the enable port 506, and the auxiliary power and spare I/O port 508. As described herein, the arrangement of the ports 500 and the signals communicated to the ports 500 provide efficient operation of the battery pack 100 and improve the control of the battery pack 100 when compared to conventional battery packs.

In general, the auxiliary power terminal 520 is configured to supply auxiliary power from the battery cells 202 at a first power level. In some embodiments, the first power level is less than is less than about 200 Watts (W), or less than about 150 W, or less than about 100W. The auxiliary power terminal 520 may supply the auxiliary power after an activation signal is received at the low-power enable terminal 516 of the enable port 506. The auxiliary power provided at the auxiliary power terminal 520 may be supplied to auxiliary components on outdoor power equipment or a chore product, such as gauges, display screens, user interfaces, sensors, controllers, ECUs, and other auxiliary or low-power components. The auxiliary power supplied at the auxiliary power terminal 520 may be insufficient to operate drive motor(s) or chore motor(s) (e.g., cutting blade motors, traction motors, or any electric device that is configured to move a component, etc.).

The I/O terminal 522 may be configured for different uses depending on the application and/or the equipment/product being powered by the battery pack 100. In some embodiments, the I/O terminal 522 may be used as an inhibit pin (e.g., an inhibit terminal) and/or an emergency stop pin. For example, if a user of outdoor power equipment or a chore product engages an emergency stop button, a signal (e.g., an inhibit signal) may be sent to the BMS 218 of the battery pack 100, via the I/O terminal 522 to stop supplying power to the positive and negative battery ports 502, 510. In some embodiments, engaging an emergency stop results in deactivation of a signal supplied to the I/O terminal 522 during operation, which may have the same effect as supplying a signal to the I/O terminal 522 (i.e., stop supplying power to the positive and negative battery ports 502, 510).

In some embodiments, the I/O terminal 522 may be used as an inhibit pin to cut off the supply of power when the battery pack 100 is not connected to outdoor power equipment/chore product or a battery charger. For example, when the battery pack 100 is connected to an equipment/product or to a battery charger, a signal may be sent to the BMS 218 of the battery pack 100, via the I/O terminal 522 indicating that that the battery pack 100 is connected to the equipment/product or charger. If this signal is lost for any reason, for example because the battery pack 100 has become disconnected, an operator presence sensor (e.g., a seat switch) does not detect an operator, or there is an electrical fault within the equipment/product or charger, the BMS 218 may instruct the battery pack 100 to stop supplying power to the equipment/product or stop receiving power from the charger via the positive and negative battery ports 502, 510. In some embodiments, the inhibit signal may also cause the battery pack 100 to stop supplying (or receiving) power via the auxiliary power terminal 520. In some embodiments, the inhibit signal may also cause the BMS 218 of the battery pack 100 to cut off communication between the battery pack 100 and the equipment/product or charger via the data ports (e.g., the CAN port 504, the enable port 506, etc.). In some embodiments, an inhibit signal may be received from the CAN bus of the equipment via the CAN port 504.

### High Power Enable

In general, the connector 115 of the battery pack 100 is configured to enable (e.g., output) high power from the battery cells 202 at the positive and negative battery ports 502, 510 in response to two separate and sequential commanded actions. The use of two separate and sequential commanded actions aids in preventing unintended high power from being supplied at the positive and negative battery ports 502, 510. With reference to FIGS. 26-27, the low-power enable terminal 516 is configured to receive an activation signal indicating a request for auxiliary power. In response to the BMS 218 detecting the activation signal at the low-power enable terminal 516, the BMS 218 may enable the battery cells 202 of the battery pack 100 to provide an auxiliary power output at the auxiliary power terminal 520. In some embodiments, a button or a switch 524 (e.g., a key switch) may send the activation signal to the low-power enable terminal 516. In some embodiments, to enable the auxiliary power at the auxiliary power terminal 520, the low-power enable terminal 516 is pulled low and connected to the negative voltage from the battery cells 202 (e.g., by activation of the button or key switch 524). Once the BMS 218 detects that the low-power enable terminal 516 has been supplied with the negative battery voltage, auxiliary power may be supplied from the battery cells 202 at the auxiliary power terminal 520 with a maximum power output being limited to the first power level. As described herein, the auxiliary power at the auxiliary power terminal 520 may be utilized to power auxiliary components on outdoor power equipment or a chore product.

After the low-power enable terminal 516 receives the activation signal and auxiliary power is supplied at the auxiliary power terminal 520, the high-power enable terminal 518 may receive an activation signal indicating a request for high power, and may enable the battery cells 202 to supply power to the positive and negative battery ports 502, 510 at a second power level that is greater than the first power level. In some embodiments, the second power level is greater than or equal to about 500W, or greater than or equal to about 1000W, or greater than or equal to about 1500W. In some embodiments, a user may press a button, position a switch, or activate a button on a display screen to trigger sending of the activation signal to the high-power enable terminal 518, which may indicate that an outdoor power equipment or a chore product is in an on condition (e.g., a ready-to-run condition). In some embodiments, to enable power at the positive and negative battery ports 502, 510, the high-power enable terminal 518 is pulled high and supplied with a positive voltage from the battery cells 202 by the auxiliary power from the auxiliary power terminal 520. Once the activation signal is received at the high-power enable terminal 518, power may be supplied from the battery cells 202 at the positive and negative battery ports 502, 510 to the drive motor(s) and/or chore motor(s) on the outdoor power equipment/chore product.

As shown in FIG. 26, the enable port 506 is separated from the positive battery ports 502, with the enable port 506 being positioned in the middle of the connector 115 and the positive battery ports 502 being positioned on the first or left side of the connector 115. For example, the CAN port 504 may be positioned to separate (e.g., between) the enable port 506 from the positive battery ports 502. The separation between the high-power enable terminal 518 and the positive battery ports 502 aids in preventing the positive voltage from the battery cells 202 from inadvertently reaching the high-power enable terminal 518 and activating high power at the positive and negative battery ports 502. For example, the CAN port 504 is arranged between the positive battery ports 502 and the enable port 506 because the signals in the CAN port 504 are not capable of supplying an activation signal to the high-power enable terminal 518 (e.g., the CAN signals are not at a voltage that corresponds with the positive voltage of the battery cells 202).

In some embodiments, when the battery pack 100 is connected to a piece of equipment or chore product that includes CAN communication capabilities, the CAN port 504 may perform some of the functionality of the ports 500 (e.g., the high-power enable terminal 518, the I/O terminal 522, etc.). For example, when the battery pack 100 is connected to a CAN-enable piece of equipment/product, the low-power enable terminal 516 may first be activated so that auxiliary power can flow from the auxiliary power terminal 520 to a controller/ECU 526 (e.g., processor and memory) of the equipment/product. Once the controller 526 is powered, the controller 526 can communicate with the battery pack 100 via the CAN port 504 of the connector 115. Rather than using the high-power enable terminal 518 to enable power to be supplied at the positive and negative battery ports 502, 510, the activation signal can be provided by a CAN signal from the controller 526 to the CAN port 504, which is received by the BMS 218. If the equipment is CAN enabled, the BMS 218 may be configured to enable the positive and negative battery ports 502, 510 only via a command received at the CAN port 504, and any signals to the high-power enable terminal 518 may be disregarded. In other embodiments, the activation signal for enabling the positive and negative battery ports 502, 510 may be received at either of the high-voltage enable terminal 518 or the CAN port 504.

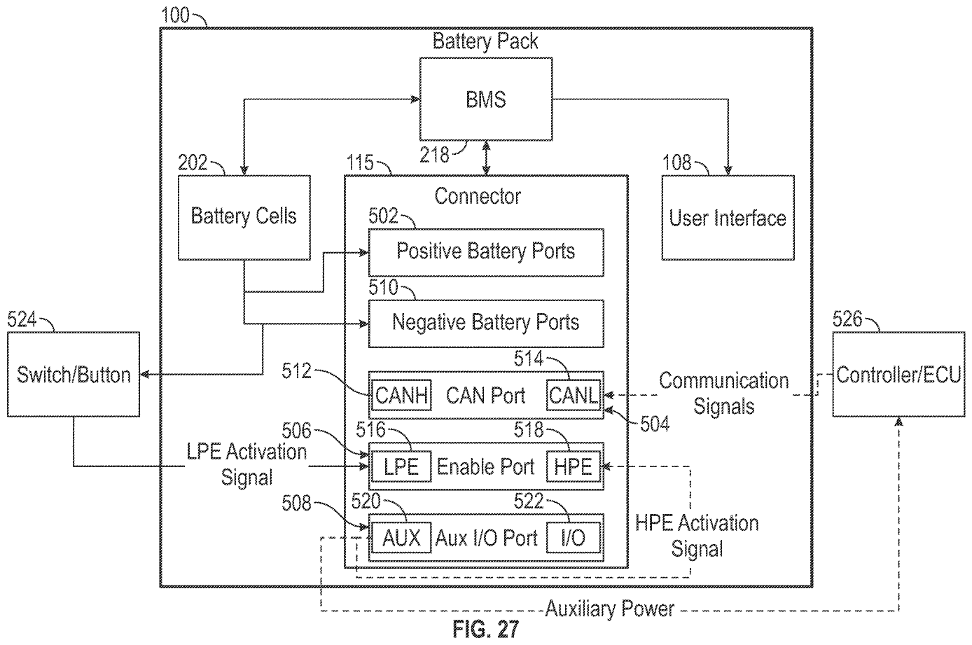

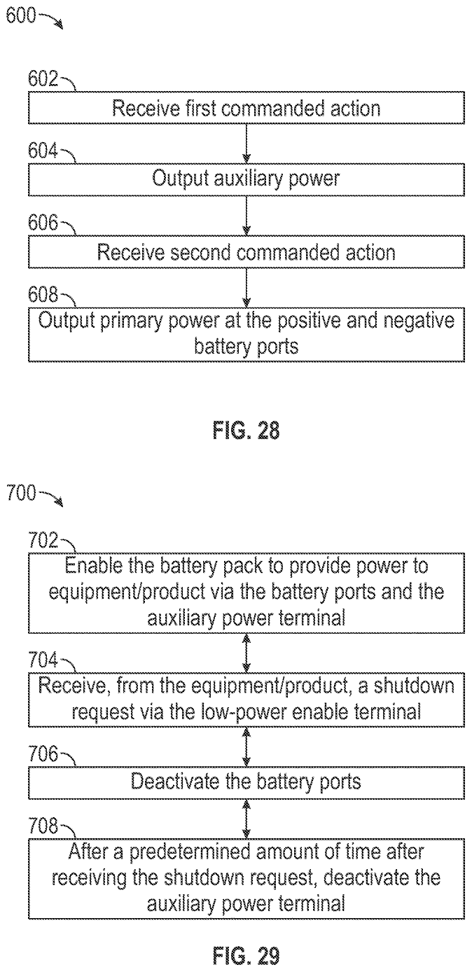

With specific reference to FIG. 28, a method 600 for enabling high power output from a battery pack is shown according to an exemplary embodiment. The method 600 begins at step 602 where a first commanded action is input to the connector 115. The first commanded action includes the button or switch 524 sending an activation signal (e.g., negative battery cell voltage) to the low-power enable terminal 516. In some embodiments, the BMS 218 detects the first commanded action at the low-power enable terminal 516. After receiving the first commanded action at step 602, the BMS 218 enables auxiliary power at the auxiliary power terminal 520 at step 604. In some embodiments, the auxiliary power supplies electrical power to a controller or an ECU on a chore product or outdoor power equipment (e.g., the controller 526). With the auxiliary power being output at step 604, a second commanded action is input to the connector at step 606. In some embodiments, the second commanded action includes supplying an activation signal from the auxiliary power terminal 520 to the high-power enable terminal 518. In some embodiments, the second commanded action includes supplying a CAN signal from a controller or an ECU that is powered by the auxiliary power to the CAN port 504. The BMS 218 detects either the activation signal at the high-power enable terminal 518 or the CAN signal at the CAN port 504 and confirms receiving both the first commanded action and the second commanded action. With the first commanded action and the second commanded action confirmed, the BMS 218 provides output power from the battery cells 202 at the positive and negative battery ports 502, 510 at the second power level. In some embodiments, the first commanded action and the second commanded action (e.g., activation or enable signals) may be continuously supplied to the connector 115 to enable operation of the battery pack 100, and deactivation of the enable signals may stop operation of the battery pack 100.

### Controlled Shutdown

In some embodiments, it may be desirable for the battery pack 100 to continue to supply power after the low-power enable terminal 516 receives a shutdown signal or stops receiving an enable signal from the equipment/product (i.e., the low-power enable terminal 516 is deactivated). For example, when a user turns equipment/product off, the equipment/product stops sending enable signals to the high-power enable terminal 518 and low-power enable terminal 516 and/or sends a deactivate signal, so that the battery pack 100 stops supplying power. However, in some cases, the equipment/product may still require power after being turned off so that the equipment/product can perform an orderly shutdown to prevent data loss, data corruption, or other issues with the controller/ECU, motor controllers or other electrical components. In some embodiments, when the low-power enable terminal 516 stops receiving an enable signal and/or receives a deactivation signal, the battery pack 100 may be configured to continue to supply power to the equipment/product via the auxiliary power terminal 520 for a predetermined amount of time. The predetermined amount of time may be an amount of time sufficient for the equipment/product to perform the shutdown operations. For example, the predetermined amount of time may be about one second, about two seconds, about five seconds, or about ten seconds, or a longer or shorter length of time. In some embodiments, when the low-power enable terminal 516 stops receiving an enable signal and/or receives a deactivation signal, the high-power enable terminal 518 and the power output from the positive and negative battery ports 502, 510 may be immediately deactivated (if they have not already been deactivated based on signals received at the high-power enable terminal 518), while the auxiliary power output from the auxiliary power terminal 520 continues for the predetermined period of time.

FIG. 29 illustrates a method 700 of enabling a controlled shutdown of equipment/product coupled to the battery pack 100, according to some embodiments. The method 700 may be performed, for example, by the BMS 218 of the battery pack 100. At step 702, the battery pack 100 may be enabled to provide power to the equipment/product via the positive and negative battery ports 502, 510 and the auxiliary power terminal 520. For example, when the equipment/product is in the running condition, the battery pack 100 may provide auxiliary power for controllers (e.g., the controller 526), user interfaces, gauges, etc. of the equipment/product via the auxiliary power terminal 520, and may provide power to the drive motors (e.g., wheel motors), chore motors (e.g., mower blade motors), and other components of the equipment/product via the positive and negative battery ports 502, 510. At step 704, a shutdown request (e.g., a shutdown signal or a deactivation signal) may be received from the equipment (e.g., from the controller 526) via the low-power enable terminal 516. For example, an operator of the equipment/product may depress a button or flip a switch indicating a desire to shut down the equipment/product, and the equipment/product (e.g., the ECU/controller 526) may send a shutdown request or a deactivation signal that is received by the low-power enable terminal 516. In some embodiments, the deactivation signal or shutdown request includes removal of the activation or enable signal at the low-power enable terminal 516 (e.g., the negative voltage from the battery cells 202 supplied to the low-power enable terminal 516 is removed), rather than sending another signal.

At step 706, the positive and negative battery ports 502, 510 may be deactivated in response to the low-power enable terminal 516 being deactivated. In some embodiments, the positive and negative battery ports 502, 510 may be shut down immediately upon the low-power enable terminal 516 being deactivated. At step 708, the auxiliary power terminal 520 is deactivated after a predetermined amount of time. The predetermined amount of time may be an amount of time sufficient for the equipment/product to complete shutdown procedures in a controlled manner. All power is then cut off from the battery pack 100 to the equipment/product after the predetermined amount of time.

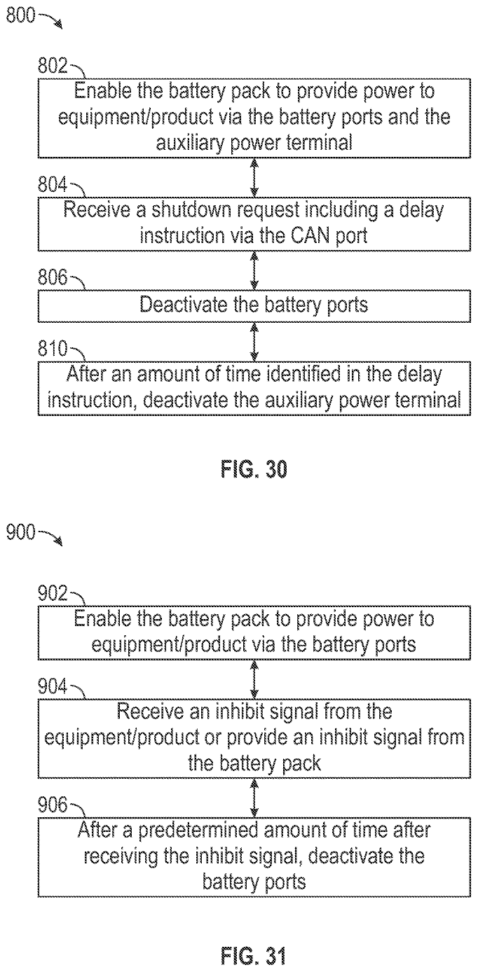

In a CAN-enabled equipment/product, a shutdown command from an ECU/controller (e.g., the ECU/controller 526) on the equipment/product may be received via the CAN port 504 and may include an instruction to delay the deactivation of the auxiliary power terminal 520 for a predetermined amount of time, so that the equipment/product may complete its shutdown procedures. FIG. 30 illustrates a method 800 of enabling a controlled shutdown of CAN-enabled equipment/product coupled to the battery pack 100, according to an exemplary embodiments. The method 800 may be performed, for example, by the BMS 218 of the battery pack 100. At step 802, the battery pack 100 may be enabled to provide power to the equipment via the positive and negative battery ports 502, 510 and the auxiliary power terminal 520. For example, when the equipment/product is in the running condition, the battery pack 100 may provide auxiliary power for controllers (e.g., the controller 526), user interfaces, gauges, etc. of the equipment/product via the auxiliary power terminal 520, and may provide power to the drive motors (e.g., wheel motors), chore motors (e.g., mower blade motors), and other components of the equipment/product via the positive and negative battery ports 502, 510. At step 804, a shutdown request (e.g., a shutdown signal) may be received from the equipment/product (e.g., from the ECU/controller 526) via the CAN port 504. For example, an operator of the equipment/product may depress a button or flip a switch indicating a desire to shut down the equipment, and the equipment/product (e.g., the ECU/controller 526) may send a shutdown request via the equipment's CAN bus that is received by the CAN port 504. The shutdown request may include a delay instruction including an indication of an amount of time that the battery pack 100 should continue to supply power via the auxiliary power terminal 520 after the shutdown request is received. The amount of time may be specific to the needs of the equipment/product. For example, a shutdown request from an equipment/product that requires four seconds to safely shut down may send a shutdown request with a delay instruction that instructs the battery pack 100 to continue to supply auxiliary power via the auxiliary power terminal 520 for greater than four seconds (e.g., five seconds). At step 806, the positive and negative battery ports 502, 510 may be deactivated in response to receiving the shutdown request. In some embodiments, the positive and negative battery ports 502, 510 may be shut down immediately upon receipt of the shutdown request. At operation 2808, the auxiliary power terminal is deactivated after the amount of time indicated in the delay instruction. All power is then cut off from the battery pack 100 to the equipment.

In some embodiments, the battery pack 100 may also continue to supply power via the auxiliary power terminal 520 for a predetermined amount of time in the event of an emergency stop or inhibit signal that is received at the I/O terminal 522. In some embodiments, one or more motors on an equipment/product may be running when the inhibit signal is received (e.g., because the operator has engaged the emergency stop or an operator presence sensor no longer detects the operator), the battery pack 100 may also not immediately cut off the high power output from the positive and negative battery ports 502, 510. Instead, the positive and negative battery ports 502, 510 may continue to supply power to the equipment so that the motors can be shut down by the motor controllers rather than cutting the power to the motors while they are actively operating.

FIG. 31 illustrates a method 900 of enabling a controlled shutdown of an equipment/product coupled to the battery pack 100, according to an exemplary embodiment. The method may be performed, for example, by the BMS 218 of the battery pack 100. At step 902, the battery pack 100 may be enabled to provide power to the equipment/product via the positive and negative battery ports 502, 510 and the auxiliary power terminal 520. At step 904, the battery pack 100 may receive an inhibit signal from the equipment/product (e.g., from the ECU/controller 526), via the I/O terminal 522 (e.g., the inhibit pin). The inhibit signal may indicate that an emergency stop button has been pressed, that an operator presence sensor or switch no longer detects an operator, or that an electrical or other fault or error has been detected by the equipment/product (e.g., by the ECU/controller 526) or the battery pack 100 (e.g., by the BMS 218).

In some embodiments, instead of receiving an inhibit signal from the equipment when an emergency stop button has been pressed, when an operator presence sensor or switch no longer detects an operator, or when a fault is detected, the equipment/product may provide a signal to the I/O terminal 522 during normal that indicates that the battery pack 100 is either discharging or charging (e.g., when the connector 115 is connected to a charger). When the signal supplied to the I/O terminal 522 that indicates normal operation is deactivated (e.g., an inhibit signal), it may provide an indication that a component connected to the battery pack 100 (e.g., a motor, a motor controller, etc.) intends to shut down. At step 906, in response to receiving the inhibit signal, the positive and negative battery ports 502, 510 may be deactivated after a predetermined amount of time. This may give the components coupled to the battery pack 100 (e.g., motor controllers) sufficient time to safely shut down the motors before losing power from the battery pack 100.

In some embodiments, at step 904, the battery pack 100 may send an inhibit signal from the I/O terminal 522 to the equipment/product indicating that power will be deactivated after the predetermined amount of time. In this way, for example, the I/O terminal 522 may be a bi-directional terminal that is both configured to send signals from the BMS 218 and receive signals that are intended for the BMS 218. For example, if the battery pack 100 experiences an electrical fault, the BMS 218 of the battery pack 100 may send the inhibit signal to the ECU/controller of the equipment/product indicating that power will be deactivated after the predetermined amount of time, allowing the ECU/controller and/or the motor controllers of the equipment/product to safely shut down the motors before the power from the battery pack 100 is shut off. In some embodiments, the ECU/controller of the equipment/product may determine that the equipment/product should be shut down before the battery pack 100 determines that power should be cut off. In this case, the ECU/controller and or the motor controllers of the equipment/product may begin the shutdown procedure before or at the same time the inhibit signal is sent from the I/O terminal 522.

### Controllable Circuit Element

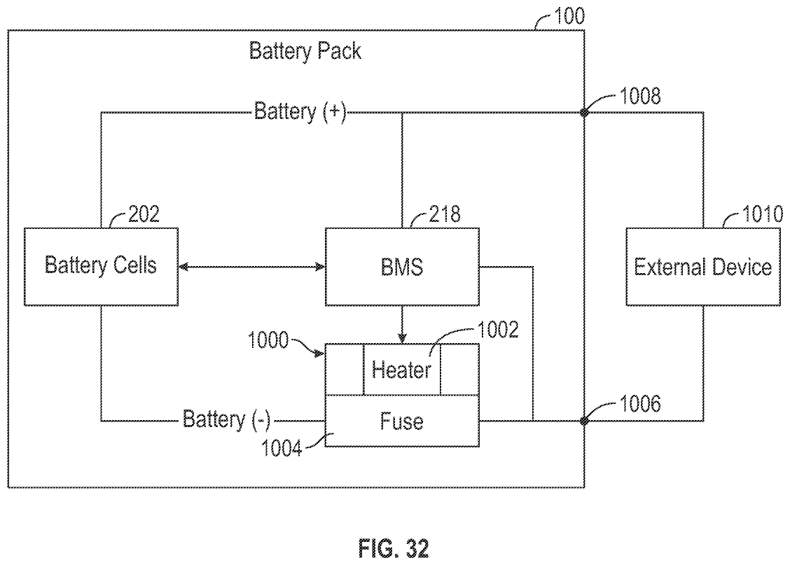

Referring now to FIG. 32, in some embodiments, the battery pack 100 includes a circuit element 1000 that is connected to either the positive side (e.g., high side, battery (+)) or the negative side (e.g., low side, battery (−)) of the battery cells 202. In general, the circuit element 1000 is a controllable fuse or disconnect that is configured to selectively disconnect the battery cells 202 from the outside world (i.e., the battery cells 202 cannot provide power to the primary power terminals/ports of the connector 115 (discharge) or receive power from the primary power terminals/ports (charge)). The circuit element 1000 is in communication with the BMS 218 and the BMS 218 is configured to send a disconnect signal (e.g., current) to the circuit element 1000 that triggers the disconnect process. The circuit element 1000 is designed so that a low current is capable of triggering the disconnect process, which enables the BMS 218 to send the disconnect signal with no external current flowing into the battery pack 100 (i.e., the disconnect process is triggered and carried out using components and signals all internal to the battery pack 100). The controllable properties of the circuit element 1000 (e.g., selectively triggering the disconnect process via the BMS 218) enable the circuit element to provide improved protection after an over-voltage charging event and/or after a high-current discharge event.

In the illustrated embodiment, the circuit element 1000 includes a heating element 1002 and a fuse 1004. In some embodiments, the heating element 1002 is in the form of a resistive heating element that generates heat in response to a current flowing through the resistive heating element. The circuit element 1000 is connected in-line with the negative side (e.g., low side, battery (−)) of the battery cells 202. In other words, the circuit element 1000 is connected between a negative terminal of the battery cells 202 (e.g., the corresponding sense board 201 or 204 connected to the negative side of the battery cells 202) and a negative battery port 1006, with the fuse 1004 being arranged in series with the negative terminal of the battery cells 202 and the negative battery port 1006. Connecting the circuit element 1000 on the negative side of the battery cells 202 ensures that the negative side of the battery cells 202 is disconnected independently from the positive side of the battery cells 202, and advantageously separates the circuit element 1000 from a precharge circuit and a bleed circuit. For example, the precharge circuit and the bleed circuit both include current that flows through a positive battery port 1008 connected to the positive side of the battery cells 202, and this current avoids the circuit element 1000 due to its connection to the negative side of the battery cells 202, thereby reducing the likelihood of inadvertently triggering a disconnect process in the circuit element 1000. In some embodiments, the circuit element 1000 may be connected on the positive side of the battery cells 202, for example, between the positive terminal of the battery cells 202 (e.g., the corresponding sense board 201 or 204 connected to the positive side of the battery cells 202) and the positive battery port 1008.

The fuse 1004 includes a fuse element (e.g., metal plate/strip) connected in series with the negative side of the battery cells 202. In some embodiments, the fuse 1004 may include one or more fuse elements arranged in series. The heating element 1002 is thermally connected to the fuse 1004 so that heat generated by the heating element 1002 is transferred to the fuse 1004 and results in the fuse 1004 melting and creating an open circuit or disconnecting the battery cells 202 from the negative battery port 1006 and the positive battery port 1008. Once the disconnect process is carried out with the circuit element 1000, current can no long flow through the fuse 1004 and the negative battery port 1006 and the positive battery port 1008 can no longer output power (discharge) or receive power (charge). In addition to the selective disconnect properties provided by the heating element 1002, the fuse 1004 itself is designed to melt and carry out a disconnect process at a predetermined threshold current that is greater than a rated operating current of the battery cells 202.

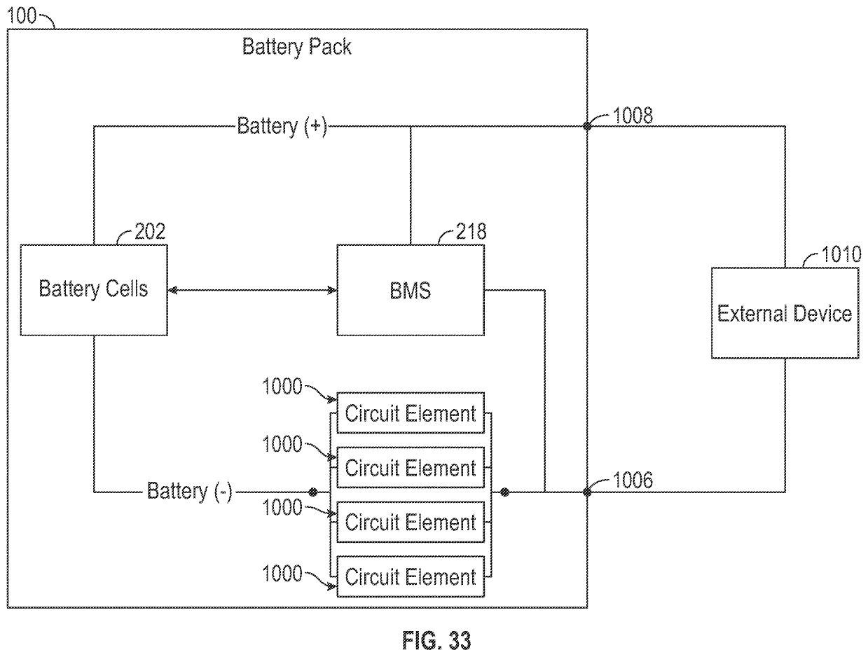

In some embodiments, a plurality of the circuit elements 1000 may be arranged in parallel, as shown in FIG. 33, to increase the predetermined threshold current (e.g., relative to the threshold current of a single circuit element) that triggers a disconnect event via the fuse 1004 (i.e., without input from the heating element 1002). For example, if the predetermined threshold current for the battery cells 202 is 160 A and the fuse 1004 in each of the circuit elements 1000 is designed to disconnect at 40 A, then four of the circuit elements 1000 may be arranged in parallel to provide disconnect functionality at 160 A.

In general, the incorporation of the heating element 1002 into the circuit element 1000 enables the circuit element 1000 to provide selective disconnect functionality in response to a signal (e.g., current) being applied to the heating element 1002 from the BMS 218. The selective disconnect functionality provided by the circuit element 1000 may be leveraged to provide improved protection, when compared to conventional battery packs, in response to an over-voltage charging event and/or an high-current discharge event. For example, the current required by the heating element 1002 to melt the fuse 1004 and achieve an electrical disconnect is relatively low compared to normal operating currents of the battery pack 100. In some embodiments, the current required by the heating element 1002 to achieve a disconnect through the fuse 1004 is less than or equal to about 2 A, or less than or equal to about 1 A. The low current required by the heating element 1002 to achieve an electrical disconnect enables the BMS 218 to send the signal to the heating element 1002 and does not require any external current that flows into the battery pack 100. In other words, the circuit element 1000 provides selective disconnect functionality using components and signals that are all internal to the battery pack 100 (i.e., arranged within the housing 120), which negates the need to incorporate a large transistor into the battery pack 100 or an equipment/product to which the battery pack 100 supplies power.

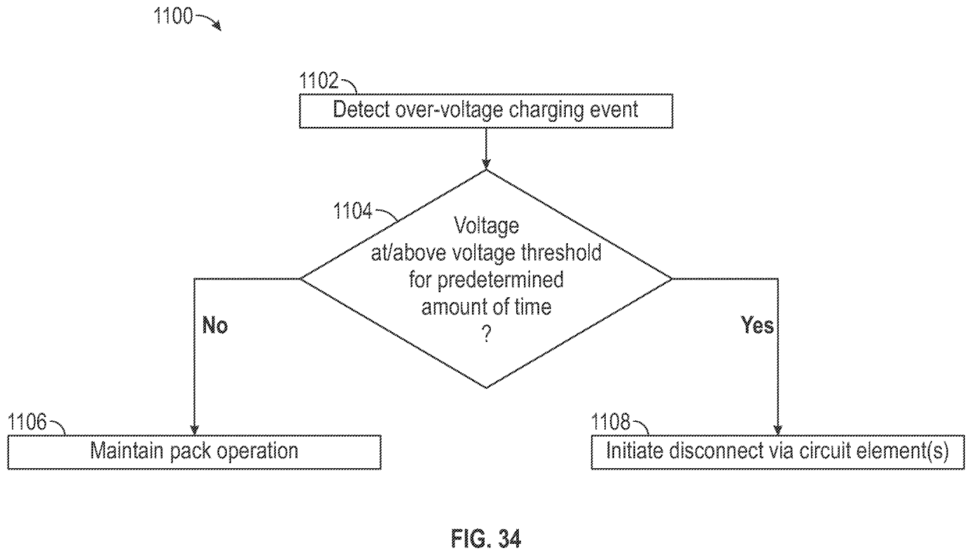

With reference to FIGS. 32 and 34, during operation, the battery pack 100 may be electrically connected to an external device 1010. In some embodiments, the external device 1010 may be in the form of an electric motor, or another electric load, on a chore product or an outdoor power equipment that is powered by the battery pack 100. In some embodiments, the external device 1010 may be in the form of a charger that supplies power to the battery pack 100. In any case, the external device 1010 is electrically connected to the negative battery port 1006 and the positive battery port 1008.

FIG. 34 illustrates a method 1100 of initiating a disconnect process in the battery pack 100 after detection of an over-voltage charging event. The method 1100 may be performed, for example, by the BMS 218 of the battery pack 100. At step 1102, an over-voltage charging event is detected during charging of the battery cells 202 by the external device 1010 (e.g., a charger). In some embodiments, the over-voltage charging event is detected by the BMS 218 monitoring the voltage of the battery cells 202, or monitoring the voltage supplied by the external device 1010 between the negative battery port 1006 and the positive battery port 1008. The over-voltage charging event detected at step 1102 is indicative of the BMS 218 detecting that the voltage of the battery cells 202 or the voltage supplied by the external device 10101 between the negative battery port 1006 and the positive battery port 1008 is greater than or equal to an over-charge voltage threshold.

Once the over-voltage charging event is detected at step 1102, the BMS 218 determines, at step 1104, if the voltage of the battery cells 202 or the voltage being supplied by the external device 1010 between the negative battery port 1006 and the positive battery port 1008 is greater than or equal to the over-charge voltage threshold for a predetermined amount of time. In response to determining that the voltage of the battery cells 202 or the voltage being supplied by the external device 1010 between the negative battery port 1006 and the positive battery port 1008 is not greater than or equal to the over-charge voltage threshold for the predetermined amount of time, the BMS 218 may maintain operation of the battery pack 100 at step 1106. In response to determining that the voltage of the battery cells 202 or the voltage being supplied by the external device 1010 between the negative battery port 1006 and the positive battery port 1008 is greater than or equal to the over-charge voltage threshold for the predetermined amount of time, the BMS 218 initiates a disconnect process by sending a signal to the circuit element(s) 1000 at step 1108. Specifically, the BMS 218 supplies a current to the heating element 1002 that melts the fuse 1004 and creates an open circuit in the primary power output of the battery pack 100, which disconnects the negative battery port 1006 and the positive battery port 1008 from any external discharge or charge sources. Following the disconnect process, the battery pack 100 is rendered inoperable and protected from being used following the over-voltage charging event.

In general, the incorporation of the circuit element(s) 1000 into the battery pack 100 enable the over-voltage charge protection to be selectively managed using components and signals all internal to the battery pack 100. For example, the BMS 218 and the circuit element(s) 1000 are both arranged within the housing 120 and configured to selectively initiate a disconnect process using a low-current signal sent from the BMS 218 to the circuit element(s) 1000, which simplifies the circuit requirements on the outdoor power equipment/chore products that interface with the battery pack 100 (i.e., no external current or components are required).

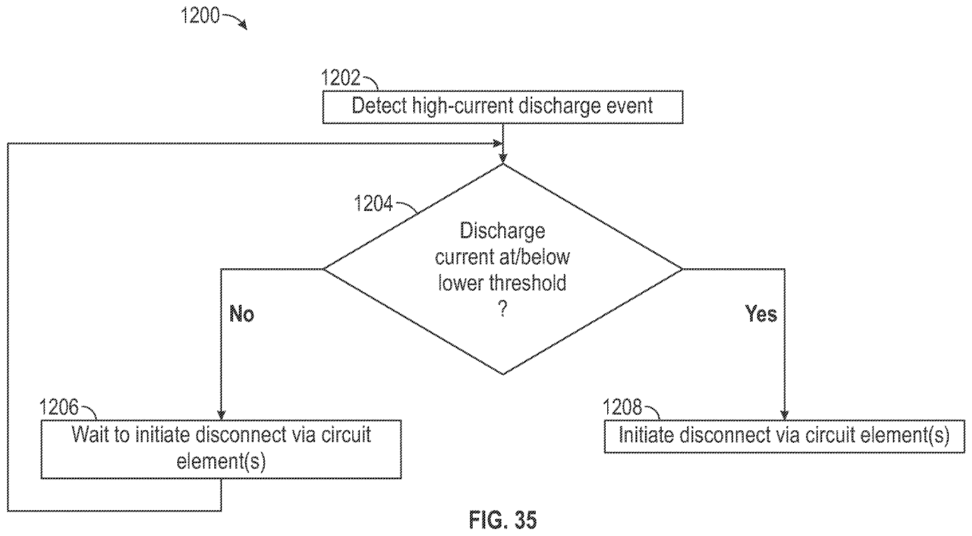

FIG. 35 illustrates a method 1200 of initiating a disconnect process in the battery pack 100 after detection of a high-current discharge event. The method 1200 may be performed, for example, by the BMS 218 of the battery pack 100. At step 1202, an high-current discharge event is detected during discharging of the battery cells 202 to the external device 1010 (e.g., an electric motor). In some embodiments, the high-current discharge event is detected by the BMS 218 monitoring the current output from the battery cells 202 to the external device 1010 (e.g., the current flowing through the negative battery port 1006 and the positive battery port 1008). For example, the battery cells 202 may supply power to an electric motor and a motor load demanded by the electric motor may increase to an operating condition where a current demanded by the motor load requires an output current from the battery cells 202 that is greater than or equal to an upper discharge current threshold. The high-current discharge event detected at step 1202 is indicative of the BMS 218 detecting that the discharge current from the battery cells 202 is greater than or equal to the upper discharge current threshold.

Once the high-current discharge event is detected at step 1202, the BMS 218, at step 1204, determines if the discharge current is less than or equal to a lower discharge current threshold. If the discharge current is not less than or equal to the lower discharge current threshold, the BMS 218 waits to initiate a disconnect process using the circuit element(s) 1000 at step 1206 and continues to monitor the discharge current at step 1204. If the discharge current is less than or equal to the lower discharge current threshold, the BMS 218 initiates a disconnect process by sending a signal to the circuit element(s) 1000 at step 1208. Specifically, the BMS 218 supplies a current to the heating element 1002 that melts the fuse 1004 and creates an open circuit in the primary power output of the battery pack 100, which disconnects the negative battery port 1006 and the positive battery port 1008 from any external discharge or charge sources. Following the disconnect process, the battery pack 100 is rendered inoperable and protected from being used following the high-current discharge event.

Because the circuit element(s) 1000 include the fuse 1004 that is configured to melt at the predetermined threshold current, the upper discharge current threshold is designed to be less than the predetermined threshold current so the fuse 1004 remains in a state that allows current flow during the high-discharge current event. In some embodiments, a plurality of the circuit elements 1000 are arranged in parallel to raise the predetermined threshold current to a value that is greater than the upper discharge current threshold by a predetermined tolerance. In this way, for example, the ability of the BMS 218 to selectively initiate the disconnect process via the circuit element(s) 1000 after the high-current discharge event.

In general, the lower discharge current threshold is less than the upper discharge current threshold, so the BMS 218 waits until the discharge current drops to a predetermined value below the upper discharge threshold before initiating the disconnect process. Waiting until the discharge current drops below the upper discharge current threshold prior to initiating the disconnect process provides improved protection to the components being powered by the battery pack 100 (e.g., an electric motor), when compared to conventional over-current disconnect procedures that are carried out during the high current. In some embodiments, the lower discharge current threshold is about 0 A and the BMS 218 waits until the motor load is removed and the battery cells 202 are in an inoperable state (e.g., not being commanded to supply power to the negative battery port 1006 and the positive battery port 1008).

### Cell Module Assembly Pads

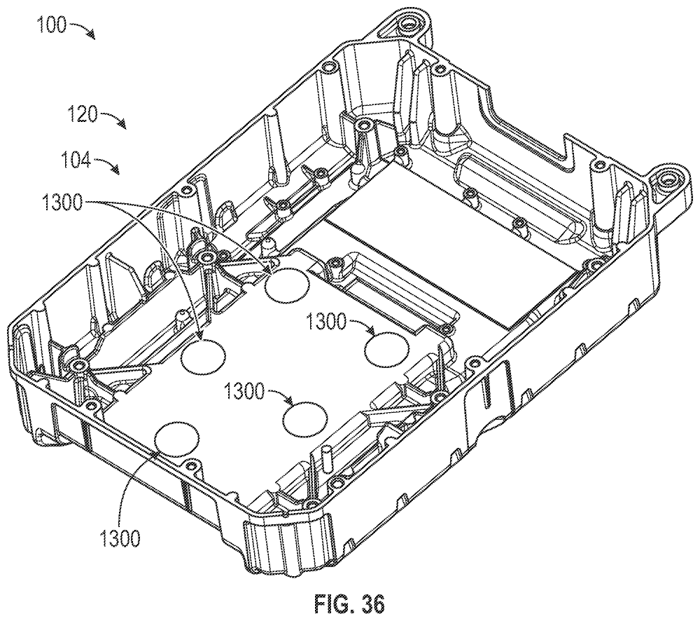

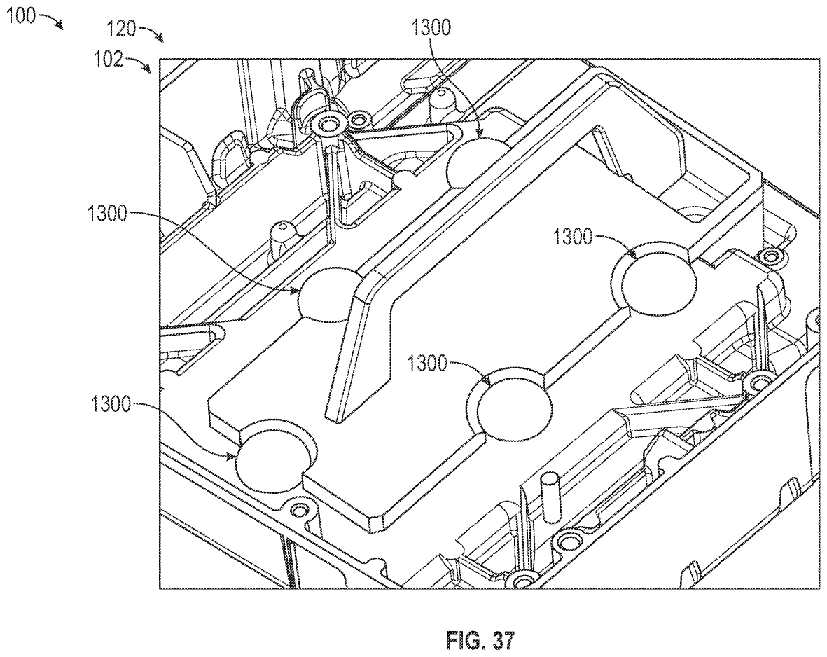

In some embodiments, the outer housing 120 may include one or more damping pads arranged between internal surfaces of the outer housing 120 and the cell module assembly 200. FIGS. 36 and 37 illustrate one or more damping pads 1300 arranged on internal surfaces of the outer housing 120. Specifically, an internal surface of the back portion 104 of the outer housing 120 includes a plurality of the damping pads 1300 (see, e.g., FIG. 36), and an internal surface of the front portion 102 of the outer housing 120 includes a plurality of the damping pads 1300 (see, e.g., FIG. 37). In some embodiments, the damping pads 1300 are fabricated from a rubber material.

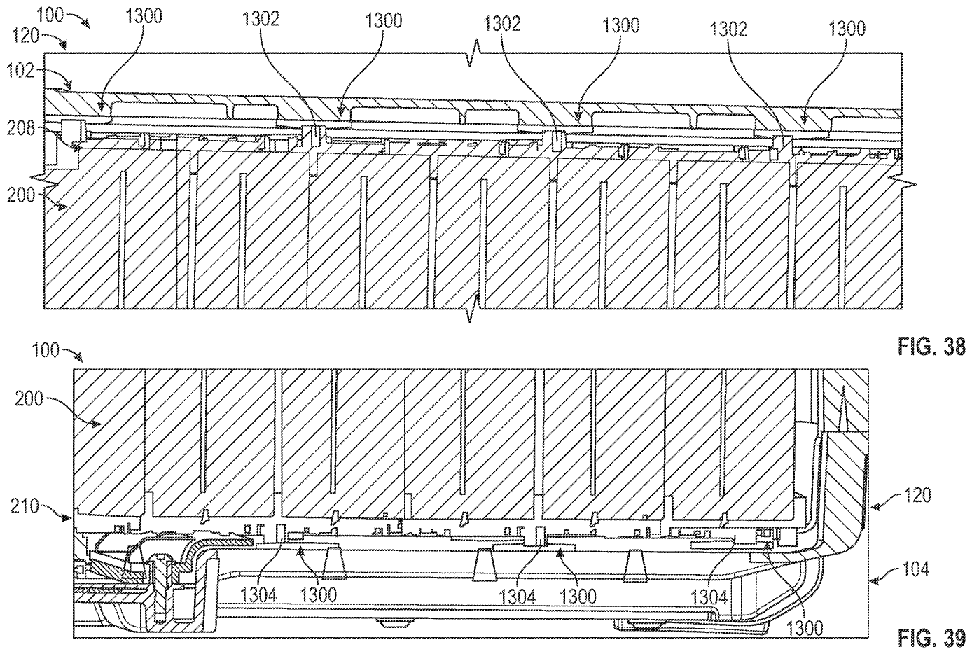

In general, the damping pads 1300 provide vibration reduction and damping to the cell module assembly 200 arranged within the outer housing 120. With specific reference to FIGS. 38 and 39, the front frame 208 of the cell module assembly 200 may include one or more posts 1302 that each extend outwardly and engage a corresponding one of the damping pads 1300 on the front portion 102 of the outer housing 120 (see, e.g., FIG. 38). The back frame 210 of the cell module assembly 200 may include one or more posts 1304 that each extend outwardly and engage a corresponding one of the damping pads 1300 on the back portion 104 of the outer housing 120 (see, e.g., FIG. 39). With the damping pads 1300 being arranged between each of the front frame 208 and the rear frame 210 of the cell module assembly 200, the damping pads 1300 may at least partially isolate the cell module assembly 200 from the outer housing 120, which provide vibration reduction and damping to the cell module assembly 200.

Although this description may discuss a specific order of method steps, the order of the steps may differ from what is outlined. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

The construction and arrangement of the suspension as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

1. A battery pack assembly comprising:
a battery pack including:
a plurality of battery cells;
a plurality of collector plates each connected to a subset of the plurality of battery cells;
a PCB sense board coupled to the plurality of collector plates through a plurality of wires;
an outer housing configured to enclose the plurality of battery cells; and
an electrical receptacle located on a side of the outer housing, the electrical receptacle comprising a plurality of ports; and
an electrical connector configured to connect to the electrical receptacle, wherein the electrical connector is coupled to a connector bracket having a pair of wings extending laterally outwardly from opposing sides of the electrical connector, each of the pair of wings is coupled to the outer housing via a fastener.

2. The battery pack assembly of claim 1, further comprising a plurality of pads, each being coupled to a corner of the outer housing.

3. The battery pack assembly of claim 1, further comprising a user interface that includes a plurality of LED lights and an activating button.

4. The battery pack assembly of claim 3, wherein the plurality of LED lights includes a first light configured to indicate a first state of charge, a second light configured to indicate a second state of charge, a third light configured to indicate a third state of charge; and a fourth light configured to indicate a fourth state of charge.

5. The battery pack assembly of claim 4, wherein the plurality of LED lights includes a fifth light configured to provide indication of at least one of a wireless connectivity or an error.

6. The battery pack assembly of claim 1, wherein the connector bracket includes a positive electrical terminal and a negative electrical terminal, and wherein a terminal cover is coupled to the connector bracket to cover the positive electrical terminal and the negative electrical terminal.

7. The battery pack assembly of claim 1, wherein the outer housing is fabricated from aluminum.

8. (canceled)

9. The battery pack assembly of claim 1, further comprising a battery management system coupled to the PCB sense board though an electrical wiring harness.

10-12. (canceled)

13. The battery pack assembly of claim 1, wherein the plurality of battery cells are arranged within a cell module assembly frame, and wherein the battery pack further includes a plurality of damping pads arranged between the outer housing and the cell module assembly frame.

14. The battery pack assembly of claim 13, wherein the cell module assembly frame includes a plurality of posts, and wherein each of the plurality of posts engages a corresponding one of the plurality of damping pads.

15. The battery pack assembly of claim 13, wherein a first portion of the plurality of damping pads are arranged on a front portion of the outer housing and a second portion of the plurality of damping pads are arranged on a rear portion of the outer housing.

16-22. (canceled)

23. A battery pack comprising:
a cell module assembly including:
a plurality of battery cells;
a plurality of collector plates each connected to a subset of the plurality of battery cells; and
a PCB sense board coupled to the plurality of collector plates through a plurality of wires;
a battery management system coupled to the PCB sense board though an electrical wiring harness;
an outer housing configured to enclose the cell module assembly;
an electrical receptacle located on a side of the outer housing, the electrical receptacle including a plurality of ports; and
an electrical connector fixed to the outer housing and including a plurality of pins, each one of the plurality of pins being received within a corresponding one of the plurality of ports.

24. The battery pack of claim 23, further comprising a plurality of pads, each being coupled to a corner of the outer housing.

25. The battery pack of claim 23, further comprising a user interface that includes a plurality of LED lights and an activating button.

26. The battery pack of claim 25, wherein the plurality of LED lights includes a first light configured to indicate a first state of charge, a second light configured to indicate a second state of charge, a third light configured to indicate a third state of charge; and a fourth light configured to indicate a fourth state of charge.

27. The battery pack of claim 26, wherein the plurality of LED lights includes a fifth light configured to provide indication of at least one of a wireless connectivity or an error.

28. The battery pack of claim 23, wherein the electrical connector is coupled to a connector bracket having a pair of wings extending laterally outwardly from opposing sides of the electrical connector, each of the pair of wings is coupled to the outer housing via a fastener.

29. The battery pack of claim 23, wherein the outer housing is fabricated from aluminum.

30. The battery pack of claim 23, wherein the plurality of battery cells are arranged within a cell module assembly frame, and wherein the battery pack further includes a plurality of damping pads arranged between the outer housing and the cell module assembly frame.

31. The battery pack of claim 30, wherein the cell module assembly frame includes a plurality of posts, and wherein each of the plurality of posts engages a corresponding one of the plurality of damping pads.

32-85. (canceled)
